(19) United States
(12) Patent Application Publication
(10) Pub. No.: US 2025/0371730 A1
(43) Pub. Date: Dec. 4, 2025

(54) PROCESSING APPARATUS, PROCESSING METHOD, AND NON-TRANSITORY COMPUTER READABLE MEDIUM

(71) Applicants: NEC Corporation, Tokyo (JP); INSTITUTE OF SCIENCE TOKYO, Tokyo (JP)

(72) Inventors: Keisuke SUZUKI, Tokyo (JP); Shuhei NOYORI, Tokyo (JP); Yuki KOSAKA, Tokyo (JP); Asuka ISHII, Tokyo (JP); Hiroo IKEDA, Tokyo (JP); Akimoto NIMURA, Tokyo (JP); Koji FUJITA, Tokyo (JP); Takuya IBARA, Tokyo (JP)

(73) Assignees: NEC Corporation, Tokyo (JP); INSTITUTE OF SCIENCE TOKYO, Tokyo (JP)

(21) Appl. No.: 19/217,000

(22) Filed: May 23, 2025

(30) Foreign Application Priority Data
Jun. 4, 2024 (JP) 2024-090352

(51) Int. Cl. G06T 7/60; G06T 7/73; G06V 10/44; G06V 10/764

(52) U.S. Cl. CPC G06T 7/60; G06T 7/73; G06V 10/44; G06V 10/764; G06T 2207/20044; G06T 2207/30196

(57) ABSTRACT

A processing apparatus according to the present disclosure includes at least one memory configured to store instructions, and at least one processor configured to execute the instructions to: receive inputs of either three-dimensional or two-dimensional skeleton key point coordinate estimation values and a gravity direction vector as input information for two images obtained by image capturing a frontal plane of a person at a time of standing and after rotation; calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and output the compensated coordinate values that have been calculated.

### INCORPORATION BY REFERENCE

This application is based upon and claims the benefit of priority from Japanese patent application No. 2024-090352, filed on Jun. 4, 2024, the disclosure of which is incorporated herein in its entirety by reference.

### TECHNICAL FIELD

The present disclosure relates to a processing apparatus, a processing method, and a program.

### BACKGROUND ART

In a medical field, analyzing the state of motion of a human body and planning treatment and rehabilitation, based on an analysis result, are widely conducted. Such an analysis has been performed with the intervention of experts such as doctors and physical therapists, for example. However, these years, development of a method for analyzing the state of the motion of the human body is progressing.

For example, Patent Literature 1 discloses a technique for applying a skeleton detection model to an image that has been captured by a camera and calculating an estimation point of a hand.

Patent Literature 1: Japanese Unexamined Patent Application Publication No. 2022-185837

### SUMMARY

Meanwhile, there is an increasing need for pose state recognition with artificial intelligence (AI) that enables rehabilitation activities through online training and self-training. However, an existing engine that estimates a skeleton key point using a learning model is low in accuracy for a rotation motion that is not included in training data. Therefore, in the AI equipped with such an engine, a pose state is evaluated, based on an estimation result of the skeleton key point with low accuracy, and therefore the recognition accuracy of the pose state is low. On the other hand, it is also possible to perform the learning including data about various rotation motions in the training data. However, in order to accurately estimate the skeleton key point, it is necessary to increase the amount of data or to reconstruct the learning model.

Hence, there is a demand for developing a technique of automatically calculating a correct skeleton key point for the estimated skeleton key point without improving an engine for estimating the skeleton key point. The technique described in Patent Literature 1 is not a technique capable of solving such a problem.

An example object of the present disclosure is to provide a processing apparatus, a processing method, and a program that are capable of automatically calculating a correct skeleton key point for an estimated skeleton key point.

According to a first example aspect of the present disclosure, a processing apparatus includes: at least one memory configured to store instructions, and at least one processor configured to execute the instructions to: receive inputs of either three-dimensional or two-dimensional skeleton key point coordinate estimation values and a gravity direction vector as input information for two images obtained by image capturing a frontal plane of a person at a time of standing and after rotation; calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and output the compensated coordinate values that have been calculated.

According to a second example aspect of the present disclosure, a processing method for causing a computer to: receive inputs of either three-dimensional or two-dimensional skeleton key point coordinate estimation values and a gravity direction vector as input information for two images obtained by image capturing a frontal plane of a person at a time of standing and after rotation; calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and output the compensated coordinate values that have been calculated.

According to a third example aspect of the present disclosure, a non-transitory computer readable medium storing a program for causing a computer to execute the following processing of: receiving inputs of either three-dimensional or two-dimensional skeleton key point coordinate estimation values and a gravity direction vector as input information for two images obtained by image capturing a frontal plane of a person at a time of standing and after rotation; calculating a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and outputting the compensated coordinate values that have been calculated.

An example effect of the present disclosure is to provide a processing apparatus, a processing method, and a program that are capable of automatically calculating a correct skeleton key point for an estimated skeleton key point.

### BRIEF DESCRIPTION OF DRAWINGS

The above and other aspects, features and advantages of the present disclosure will become more apparent through the following description of certain exemplary embodiments, in conjunction with the accompanying drawings, in which:

FIG. 1 is a block diagram illustrating a configuration example of a processing apparatus according to the present disclosure;

FIG. 2 is a diagram schematically illustrating a configuration of a part of a rotation state recognition system including the processing apparatus according to the present disclosure;

FIG. 3 is a diagram schematically illustrating a modified example of a configuration of a part of a rotation state recognition system including the processing apparatus according to the present disclosure;

FIG. 4 is a block diagram illustrating a configuration example of the rotation state recognition system including the processing apparatus according to the present disclosure;

FIG. 5 is a diagram schematically illustrating positions of skeleton key points extracted by a skeleton extraction unit;

FIG. 6 is a flowchart for describing a processing example of a learning phase;

FIG. 7 is a schematic view illustrating a compensation example of the key point of a waist part together with a silhouette image at the time of standing and a silhouette image after rotation;

FIG. 8 is a schematic view illustrating a compensation example of the key point of the shoulder part together with the silhouette image at the time of standing and the silhouette image after rotation;

FIG. 9 is a schematic view illustrating a compensation example of the key point of a knee part together with the silhouette image at the time of standing and the silhouette image after rotation;

FIG. 10 is a schematic view illustrating a compensation example of the key point of an ankle part together with the silhouette image at the time of standing and the silhouette image after rotation;

FIG. 11 is a schematic view illustrating an example of a user interface image before position compensation;

FIG. 12 is a schematic view illustrating an example of a user interface image after the position compensation;

FIG. 13 is a diagram illustrating an outline of calculation of an acromion rotation amount in each frame;

FIG. 14 is a diagram illustrating an outline of calculation of left upper arm separation in each frame;

FIG. 15 is a diagram illustrating an outline of calculation of right upper arm separation in each frame;

FIG. 16 is a diagram illustrating an outline of calculation of left lower arm bending in each frame;

FIG. 17 is a diagram illustrating an outline of calculation of right lower arm bending in each frame;

FIG. 18 is a diagram illustrating an outline of calculation of the horizontal of acromion in each frame;

FIG. 19 is a diagram illustrating an outline of calculation of upper trunk forward/backward tilting in each frame;

FIG. 20 is a diagram illustrating an outline of calculation of the horizontal of pelvis in each frame;

FIG. 21 is a diagram illustrating an outline of calculation of upper trunk lateral bending in a former frame;

FIG. 22 is a diagram illustrating an outline of calculation of the upper trunk lateral bending in a later frame;

FIG. 23 is a diagram illustrating an outline of calculation of a pelvis rotation amount in each frame;

FIG. 24 is a view illustrating a list of posture labels to recognize;

FIG. 25 is a flowchart for describing a processing example of an estimation phase;

FIG. 26 is a schematic diagram illustrating an example of a user interface image illustrating estimation results;

FIG. 27 is a view illustrating results of comparing recognition accuracy between a case where features are extracted from skeleton key points that have been manually input and a case where features are extracted from skeleton key points that have been extracted by a skeleton extraction model of a comparative example;

FIG. 28 is a view illustrating results of comparing recognition accuracy between a case where features are extracted from skeleton key points that have been extracted by the skeleton extraction model of a comparative example and a case where features are extracted from skeleton key points that have been extracted after a specific part is further automatically compensated;

FIG. 29 is a view illustrating comparison results of the skeleton key points between the skeleton key points that have been manually input and the skeleton key points that have been extracted by the skeleton extraction model of a comparative example;

FIG. 30 is a schematic view illustrating a segmentation technique;

FIG. 31 is a view illustrating another example of the list of posture labels to recognize;

FIG. 32 is a diagram schematically illustrating a modified example of a configuration of a part of the rotation state recognition system including the processing apparatus according to the present disclosure; and

FIG. 33 is a diagram schematically illustrating a configuration of a computer that is an example of a hardware configuration for achieving the processing apparatus or the rotation state recognition system.

### EXAMPLE EMBODIMENTS

Hereinafter, example embodiments will be described with reference to the drawings. Note that in the following example embodiments, identical or equivalent elements are denoted by the same reference numerals, and overlapping descriptions will be omitted. In addition, reference signs and names of elements in the drawings are attached to the respective elements for convenience as an example for promoting the understanding, and they do not limit the contents of the present disclosure at all. In addition, in some drawings, unidirectional or bidirectional arrows are drawn in the drawings to be described below. However, all the arrows simply indicate the flow direction of a certain signal (data), and do not exclude bidirectionality or unidirectionality.

### First Example Embodiment

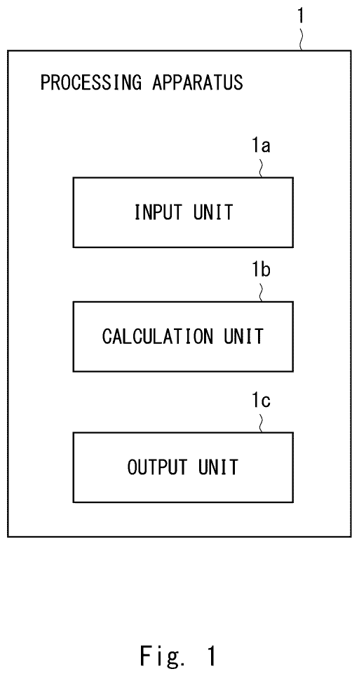

Hereinafter, a configuration example of a processing apparatus 1 will be described with reference to FIG. 1. The processing apparatus 1 includes an input unit 1a, a calculation unit 1b, and an output unit 1c. FIG. 1 is a block diagram illustrating a configuration example of the processing apparatus according to the present disclosure.

The input unit 1a receives inputs of either three-dimensional or two-dimensional skeleton key point coordinate estimation values and a gravity direction vector as input information for two images obtained by image capturing a frontal plane of a person at the time of standing and after rotation. In this specification, “rotation” of the person can mean “multi-segmental rotation” of the person. It is needless to say that after rotation can also include a case where the person is doing a rotation motion. In the case where the person is doing the rotation motion, an image after rotation denotes an image obtained by image capturing a rotation state as the input information is being input. Note that the gravity direction vector is basically the same between at the time of standing and after rotation, in a case where an image capturing apparatus that captures images is fixed. It is sufficient if one vector is input, but different ones may be input.

Here, the two images denote images that have been captured from a direction in which the frontal plane of a person is parallel to an imaging plane of the image capturing apparatus (hereinafter, a camera), that is, from a direction in which the optical axis of the image capturing center of the camera is perpendicular to the frontal plane of the person. However, since the gravity direction vector is also included in the input information, a correction can be made with the gravity direction vector, even though the frontal plane of the person is not image captured from the direction accurately parallel to the imaging plane of the camera. The camera may be a camera that captures a still image or a camera that captures a moving image. In a case where the camera captures a moving image, a frame indicating an image at the time of standing and a frame indicating an image after rotation can be input, for example, as an image designated by the user or automatically as an image after a lapse of a predetermined time from the time of standing. Alternatively, a rotation degree may be automatically detected by a change in the thickness or the like of the torso, and the image after rotation may be designated and input as an image once the thickness becomes equal to or smaller than a predetermined ratio.

Hereinafter, the skeleton key point coordinate estimation value is a three-dimensional skeleton key point coordinate estimation value expressed in an orthogonal coordinate system, the skeleton key point coordinate estimation values at the time of standing are expressed by (xᵢ, yᵢ, zᵢ), and the skeleton key point coordinate estimation values after rotation are expressed by (xⱼ, yⱼ, zⱼ). Each i and j is an integer between 1 and n, and indicates each part to be input. n indicates the number of parts to be input. However, the skeleton key point coordinate estimation values may be expressed by a polar coordinate system such as (rᵢ, θᵢ, φᵢ), that is, spherical coordinates, or may be expressed by a two-dimensional orthogonal coordinate system such as (xᵢ, yᵢ) or a two-dimensional polar coordinate system such as (rᵢ, θᵢ). Like these examples, the skeleton key point coordinate estimation value may be expressed by any coordinate system. In addition, the same reasoning applies to various coordinates such as compensated coordinate values to be described later, and in processing, it may be expressed in the same coordinate system as the skeleton key point coordinate estimation values, or may be expressed in a different coordinate system.

The calculation unit 1b calculates the width of a specific part from each of the two silhouette images respectively indicating the silhouettes of the above two images.

Here, the input information may include the above two images. That is, the above two images may be input into the input unit 1a. In this case, the calculation unit 1b may generate the above two silhouette images by, for example, extracting edges from the above two images that have been input. That is, the calculation unit 1b may include a silhouette extraction unit into which the above two images are input, and which outputs the two silhouette images of a person. Such a silhouette extraction unit can also be referred to as a silhouette generation unit.

Alternatively, the input information may include the above two silhouette images as the above two images. That is, the above two silhouette images may be input, as the above two images, into the input unit 1a.

Then, the calculation unit 1b collates the widths of a specific part calculated at the time of standing and after rotation and the gravity direction vector with the anatomical knowledge, and calculates a compensated coordinate value for the specific part in the image after rotation. Here, the compensated coordinate value is a skeleton key point coordinate value used for compensating the skeleton key point coordinate estimation value in the specific part of the image after rotation, and is calculated as a correct coordinate value, that is, a coordinate value indicating a correct position. Therefore, the calculation unit 1b can also be referred to as a compensated position calculation unit.

Hereinafter, for the sake of convenience, the three-dimensional skeleton key point coordinate estimation values for the image at the time of standing in a certain specific part are expressed by (x₁, y₁, z₁), and the three-dimensional skeleton key point coordinate estimation values for the image after rotation are expressed by (x₂, y₂, z₂). In addition, in the following description, the compensated coordinate values are expressed by (x_{2′}, y_{2′}, z_{2′}) with respect to the key point coordinate estimation values (x₂, y₂, z₂) of the three-dimensional skeleton of the above specific part for the image after rotation.

The output unit 1c outputs at least the compensated coordinate values (x_{2′}, y_{2′}, z_{2′}) that have been calculated. Note that an output destination is not limited, and may be, for example, one or a plurality of a storage device (storage apparatus), a display device (display apparatus), and a part used for calculating a feature to be described later.

In this manner, according to the processing apparatus 1, it is possible to automatically calculate the correct skeleton key point for the estimated skeleton key point. Therefore, without improving the engine for estimating the skeleton key point, it becomes possible to automatically output coordinate values obtained by compensating the estimated skeleton key point to the correct skeleton key point, based on the anatomical knowledge. In addition, in this manner, in the processing apparatus 1, it becomes possible to output the coordinate values obtained by automatically and correctly compensating the skeleton key point that has been erroneously estimated by the above engine, so that the accuracy in recognizing the pose state, for example, through AI, can be improved without improving the above engine.

### Second Example Embodiment

### (Schematic Configuration Example of Rotation State Recognition System)

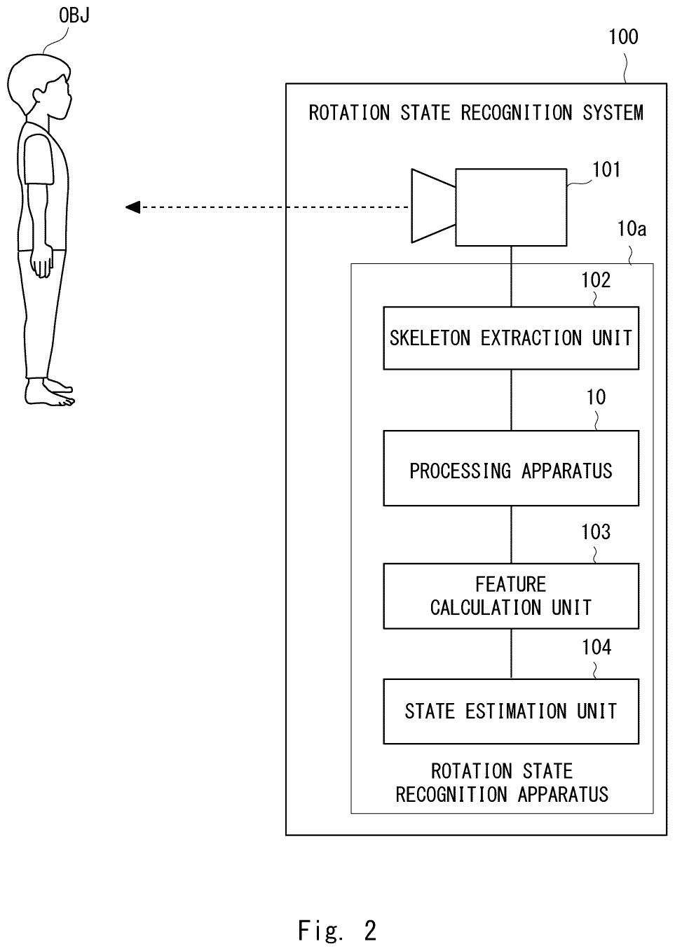

A schematic configuration example of a rotation state recognition system 100 including a processing apparatus 10, which is an example of the processing apparatus 1, will be described with reference to FIG. 2. FIG. 2 is a diagram schematically illustrating a configuration of a part of a rotation state recognition system including the processing apparatus according to the present disclosure.

The rotation state recognition system 100 is configured to estimate a motion state of a part that is to be analyzed in a case where an object OBJ makes an action of twisting the body to the right or left, that is, a rotation motion of rotating the body to the right or left, based on an image or a moving image obtained by image capturing the human body of the object OBJ. The object OBJ is an example of the person that has been described in the first example embodiment.

The rotation motion of the body mentioned here means a motion of rotation the body to the right or left in a state in which the grounding position and the directions of both legs are fixed, and at this timing, the respective parts including an upper body such as an arm, a shoulder, and a neck, a waist, and legs move in conjunction.

The rotation state recognition system 100 includes a camera 101 and a rotation state recognition apparatus 10a, which estimates and then recognizes a rotation state that is a motion state of the rotation motion. Note that the camera 101 can also be referred to as an imaging unit or an image capturing apparatus.

The camera 101 captures an image or a moving image of the object OBJ, who is to an image capturing target, and outputs data of the image or the moving image that has been captured to the rotation state recognition apparatus 10a. In the following description, it is assumed that the camera 101 outputs the moving image data to the rotation state recognition apparatus 10a. In addition, in the following description, the moving image data will be referred to as moving image data MOV.

The rotation state recognition apparatus 10a is configured to calculate a feature indicating the motion state of a part that is to be analyzed in a case where the imaged object OBJ twists the body to the right or left, based on the received moving image data MOV, and to estimate the rotation state. Therefore, the rotation state recognition apparatus 10a includes a skeleton extraction unit 102, the processing apparatus 10, a feature calculation unit 103, and a state estimation unit 104. These component elements will be described later.

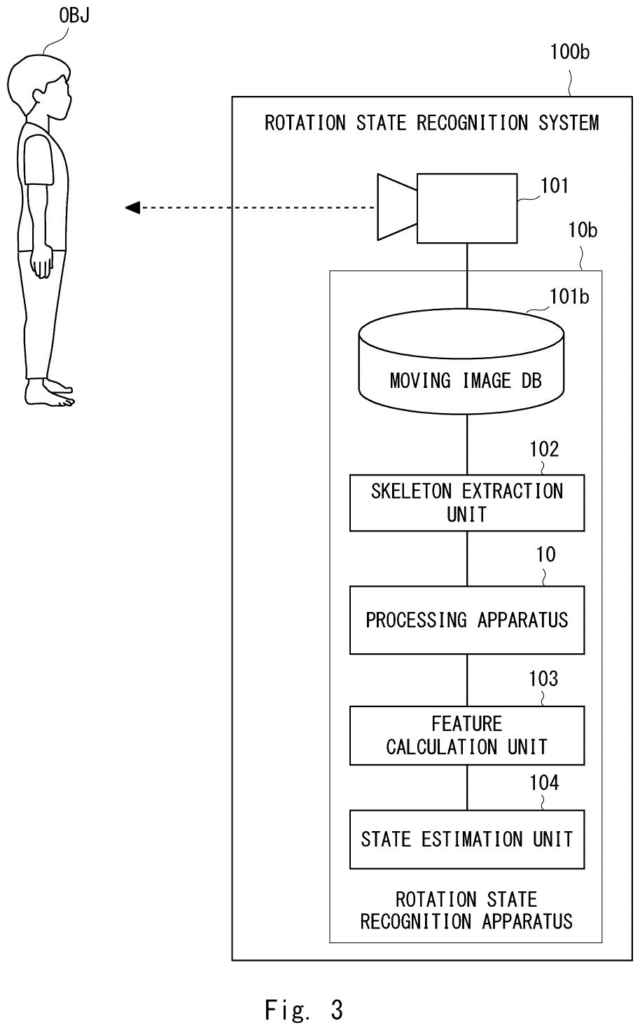

In addition, instead of the rotation state recognition system 100 illustrated in FIG. 2, a modified example such as a rotation state recognition system 100b illustrated in FIG. 3 is also adoptable. FIG. 3 is a diagram schematically illustrating a modified example of a configuration of a part of the rotation state recognition system including the processing apparatus according to the present disclosure.

As compared with the rotation state recognition system 100 in FIG. 2, the rotation state recognition system 100b in FIG. 3 includes a rotation state recognition apparatus 10b, to which a moving image database 101b is added in the rotation state recognition apparatus 10a. The moving image database 101b is configured as various types of storage devices, or is configured to be storable in various types of storage devices. In the moving image database 101b, the moving image data MOV, which has been captured by the camera 101, is appropriately stored. The rotation state recognition apparatus 10b reads the moving image data MOV from the moving image database 101b as necessary. It is needless to say that the moving image database 101b may be provided in the camera 101.

Note that in FIGS. 2 and 3, the moving image data MOV is output from the camera 101 respectively to the rotation state recognition apparatus 10a and 10b, but this is merely an example. For example, the moving image data MOV may be stored in another storage device, and the rotation state recognition apparatus 10a or the rotation state recognition apparatus 10b may read the moving image data MOV from the storage device as necessary.

### (Specific Configuration Example of Rotation State Recognition System 100)

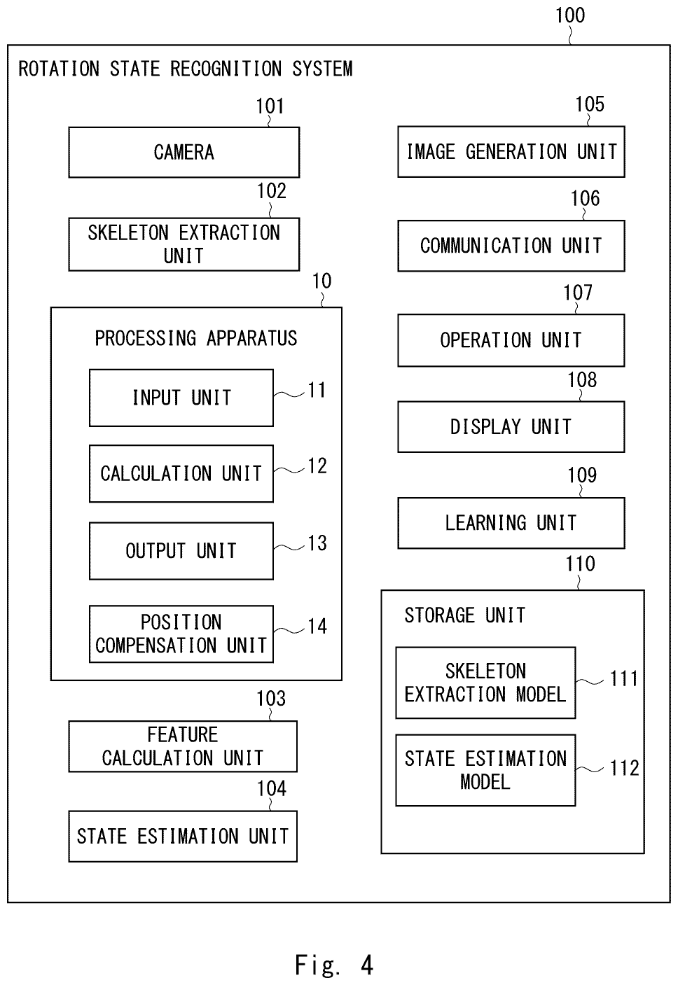

A more specific configuration example of the rotation state recognition system 100 in FIG. 2 will be described with reference to FIG. 4. FIG. 4 is a block diagram illustrating a configuration example of the rotation state recognition system including the processing apparatus according to the present disclosure. Note that in the following description, the description of a specific configuration example corresponding to the example of FIG. 3 will be omitted, but only the input and output of the moving image data MOV via the moving image database 101b are different, and the same description is applicable in the other points.

First, a flow of processing in the rotation state recognition system 100 illustrated in FIG. 4 will be schematically described. In the following description, an example in which the rotation state recognition system 100 generates a state estimation model 112 with machine learning will be described. On the other hand, in the rotation state recognition system 100, a machine learning model obtained by the machine learning in another apparatus is used for a skeleton extraction model 111. The skeleton extraction model 111 is, for example, a learned model obtained by the machine learning so as to output the skeleton key point coordinate estimation values from the moving image data MOV of the object OBJ, who is a learning target.

First, the rotation state recognition system 100 obtains the skeleton key point coordinate estimation values from the moving image data MOV using the skeleton extraction model 111. Then, the rotation state recognition system 100 causes the processing apparatus 10, which is an example of the above-described processing apparatus 1, to compensate the value of the specific part after rotation, out of the skeleton key point coordinate estimation values that have been output from the skeleton extraction model 111. The rotation state recognition system 100 calculates a rotation feature based on the position of the skeleton key point of each part of the object OBJ that has been obtained in this manner, and thus extracts the rotation feature.

Next, the rotation state recognition system 100 generates the state estimation model 112 from an unlearned model using the machine learning. The state estimation model 112 is a learned model obtained by the machine learning about a correspondence relationship between the rotation feature extracted in this manner from the moving image data MOV of the object OBJ, who is a learning target, and the rotation state of the object OBJ, who is the learning target. That is, the state estimation model 112 is a learned model obtained by the machine learning so as to estimate the rotation state of the object OBJ from the rotation feature. The rotation state can denote a motion state of the part that is to be analyzed in a case where the object OBJ, who is an estimation target, twists the body to the right or left. Examples of the skeleton extraction model 111 and the state estimation model 112 will be described later.

The rotation state recognition system 100, however, can be configured as a system that does not have a function of the machine learning, and that is used only in an estimation phase that is an operation stage. In such a case, by mounting not only the skeleton extraction model 111 but also the state estimation model 112, which has been obtained by the machine learning in another apparatus, it is possible to configure the rotation state recognition system 100.

In the estimation phase, the rotation state recognition system 100 obtains the skeleton key point coordinate estimation value from the moving image data MOV of the object OBJ using the skeleton extraction model 111, and the processing apparatus 10 compensates the value of the specific part after rotation. Then, the rotation state recognition system 100 calculates the rotation feature based on the position of the skeleton key point of each part of the object OBJ that has been obtained in this manner, and estimates the rotation state of the object OBJ from the rotation feature using the state estimation model 112.

Next, details of the rotation state recognition system 100 will be described. The rotation state recognition system 100 is, for example, a user terminal such as a smartphone, a tablet terminal, or a personal computer possessed by a user. Note that the user includes both a subject who receives the evaluation of the pose such as the rotation state using the rotation state recognition system 100, that is, the object OBJ, and an evaluator who evaluates the pose of another person using the rotation state recognition system 100. In addition, in a case where the subject evaluates his/her own pose using the rotation state recognition system 100 in self-training or the like, the subject is also the evaluator. Further, in a case where the evaluator evaluates the pose of another person using the rotation state recognition system 100, the evaluator is, for example, a therapist or a trainer. Note that in the rotation state recognition system 100 illustrated in FIG. 4, a configuration in which the camera 101 is removed from the rotation state recognition system 100 corresponds to the rotation state recognition apparatus 10a in FIG. 2.

As illustrated in FIG. 4, the rotation state recognition system 100 includes a camera 101, a skeleton extraction unit 102, a feature calculation unit 103, a state estimation unit 104, an image generation unit 105, a communication unit 106, an operation unit 107, a display unit 108, a learning unit 109, and a storage unit 110 together with the processing apparatus 10, which is an example of the processing apparatus 1. The operation unit 107 and the display unit 108 may be configured as one display equipped with a touch panel, or may be provided separately. In addition, the storage unit 110 stores the skeleton extraction model 111, the state estimation model 112, and the like.

The camera 101 is an example of the camera that has been described in the first example embodiment, and is installed so that the frontal plane of the object OBJ is parallel to an imaging plane so as to capture two images at the time of standing and after rotation. In this example, the camera 101 is a camera that captures a moving image and that outputs the moving image data MOV. The output destination can be set to the skeleton extraction unit 102 and the input unit 11 of the processing apparatus 10.

The skeleton extraction unit 102 receives the moving image data MOV from the camera 101, and designates a frame indicating an image at the time of standing and a frame indicating an image after rotation, as the above two images. As described above, this designation can be made by, for example, designation by the user or whether a predetermined time has elapsed from the time of standing automatically.

The skeleton extraction unit 102 extracts the skeleton key point coordinate values from each of the designated two images. This extraction is based on an estimation using the skeleton extraction model 111. These coordinate values are the above-described skeleton key point coordinate estimation values (xᵢ, yᵢ, zᵢ) at the time of standing and the skeleton key point coordinate estimation values (xⱼ, yⱼ, zⱼ) after rotation. The part, which is to be extracted, of the object OBJ is not limited, but may be, for example, each part such as a waist part, a shoulder part, a knee part, an ankle part, or a head part, or its one part.

The positions of the left and right waist parts can be estimated as the positions of the left and right anterior superior iliac spines, and the position of the center of the waist part can be estimated as the central position of those positions, but are not limited to them. The position of the head can be estimated, for example, from estimated positions of the eyes and estimated positions of the ears, or can be estimated as the positions of the eyes and the ears. The positions of the knee part and the shoulder part can be respectively estimated as, for example, the positions of the knee joint and the shoulder joint. However, without being limited to these examples, cervical vertebra, a hip joint, an eye, an ear, and the like may be included in the part to be extracted. In addition, the position of the cervical vertebra can be estimated as the position of prominent vertebra, but can be estimated as the position(s) of one or a plurality of the seven vertebrae that constitutes the cervical vertebra.

The skeleton key point is a point indicating the position of the skeleton, and can also be referred to as a skeleton point, position information of a key point, or the like. In addition, since the skeleton key point is a point indicating a feature of the skeleton of a person who is the object OBJ, the skeleton key point can be referred to as a feature point. Therefore, the skeleton extraction unit 102 can also be referred to as a feature point extraction unit.

In addition, the position information on an image is, for example, image coordinates. Here, the image coordinates are coordinates for indicating the position of a pixel on a two-dimensional image or a three-dimensional image in which the depth is also taken into consideration. The image coordinates of the two-dimensional image are, for example, coordinates in which the center of a pixel located on the leftmost side and the uppermost side in the two-dimensional image is set as the origin, x direction is defined as a left-right direction or a horizontal direction, and y direction is defined as an up-down direction or a vertical direction. The image coordinates of the three-dimensional image can be, set to, for example, coordinates in which z direction is defined as a direction away from the camera 101 or its opposite direction with the position of the camera 101 as the origin in the depth direction, in the image coordinates of the two-dimensional image. It is needless to say that in both the two-dimensional image and the three-dimensional image, the way of determining the origin of the coordinates and the coordinate system are not limited to them.

Using the learned skeleton extraction model 111, the skeleton extraction unit 102 extracts the key point coordinate estimation values that are coordinates obtained by estimating the position of the part that is to be extracted from the two images at the time of standing and after rotation that have been designated in the moving image data MOV, which has been input from the camera 101. Note that another apparatus of the rotation state recognition system 100 performs machine learning so as to receive inputs of two images and output the key point coordinate estimation values beforehand, thereby generating the learned skeleton extraction model 111, and the rotation state recognition system 100 stores the learned skeleton extraction model 111 in the storage unit 110. Further, the skeleton extraction model 111 may be subjected to the machine learning so as to receive inputs of the two images at the time of standing and after rotation designated in the moving image data MOV and the gravity direction vector, and to output the skeleton key point coordinate estimation values. The algorithm or the like of the skeleton extraction model 111 is not limited, and, for example, a model using deep learning or the like is used.

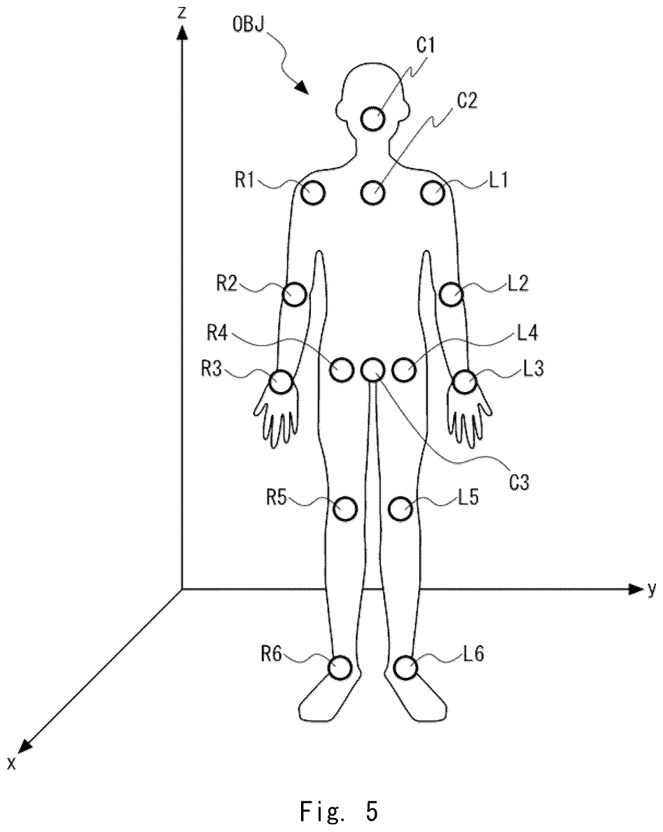

FIG. 5 schematically illustrates the position of the skeleton key point extracted as the skeleton key point coordinate estimation values by the skeleton extraction unit 102. FIG. 5 is a front view of the object OBJ from which the skeleton key point coordinate estimation values are to be extracted. However, in FIG. 5, unlike the above-described example that has been described for the image coordinates of the three-dimensional image, x direction is displayed as a direction from the back to the front of the object OBJ, and x direction is inclined for making it easier to view the drawing. In addition, in FIG. 5, y direction is displayed as a direction from the right to the left of the object OBJ, that is, a direction from the left to the right in the drawing, and z direction is displayed as a direction from the bottom to the top.

The skeleton extraction unit 102 extracts 15 skeleton key point coordinate estimation values from the object OBJ. As an example given in FIG. 5, the skeleton extraction unit 102 extracts, for example, a nose C1, a neck C2, and a waist center C3 sequentially from the top on the midline of the object OBJ, as the skeleton key point coordinate estimation values of the respective parts. Regarding a right half body, the skeleton extraction unit 102 extracts a right shoulder R1, a right elbow R2, and a right wrist R3 sequentially from the top in the right arm, and a right waist R4, a right knee R5, and a right ankle R6 sequentially from the top in the right waist part and the right lower limb, as the skeleton key point coordinate estimation values of the respective parts. Regarding a left half body, the skeleton extraction unit 102 extracts, symmetrically with respect to the right half body, a left shoulder L1, a left elbow L2, and a left wrist L3 sequentially from the top in the left arm, and a left waist L4, a left knee L5, and a left ankle L6 sequentially from the top in the left waist part and the left lower limb, as the skeleton key point coordinate estimation values of the respective parts.

The above-described rotation feature is a feature indicating a rotation state between the time while the object OBJ is standing and after the object OBJ makes a rotation motion, and is schematically extracted as follows, for example. That is, the skeleton extraction unit 102 estimates the skeleton key point coordinate values of each skeleton key point for two images designated as the images at the time of standing and after rotation in the moving image data MOV, and provides the processing apparatus 10 with the skeleton key point coordinate estimation values, which are the estimated coordinate values. The processing apparatus 10 compensates the skeleton key point coordinate estimation values of a specific part in the skeleton key point coordinate estimation values that have been input with compensated coordinate values, and outputs the skeleton key point coordinate values for each skeleton key point including a compensated value to the feature calculation unit 103. Regarding the skeleton key point that is not to be compensated, it is sufficient for the processing apparatus 10 to output the skeleton key point coordinate estimation values that have been input without change, as the skeleton key point coordinate values. Then, the feature calculation unit 103 calculates the rotation feature based on the skeleton key point coordinate values that have been input, and then extracts the rotation feature.

More specifically, first, the skeleton extraction unit 102 provides the processing apparatus 10 with the two images at the time of standing and after rotation and the skeleton key point coordinate estimation values (xᵢ, yᵢ, zᵢ) and (xⱼ, yⱼ, zⱼ) of each part in those two images. In addition, the skeleton extraction unit 102 also provides the processing apparatus 10 with the gravity direction vector that has been received from the camera 101. The processing apparatus 10 includes an input unit 11, a calculation unit 12, and an output unit 13, which are the respective examples of the input unit 1a, the calculation unit 1b, and the output unit 1c in FIG. 1, and also includes a position compensation unit 14.

The processing apparatus 10 receives the two images, the skeleton key point coordinate estimation values (xᵢ, yᵢ, zᵢ) and (xⱼ, yⱼ, zⱼ) of each part, and the gravity direction vector by the input unit 11. Then, the input unit 11 provides the calculation unit 12 with the two images, the skeleton key point coordinate estimation values (x₂, y₂, z₂) of a specific part after rotation, and the gravity direction vector. In addition, the input unit 11 provides the output unit 13 with the skeleton key point coordinate estimation values (x₁, y₁, z₁) of the above specific part at the time of standing and the skeleton key point coordinate estimation values of another part. The above specific part can be determined beforehand as one or a plurality of parts to be compensated, and it is needless to say that it may be all parts that have been extracted by the skeleton extraction unit 102.

The calculation unit 12 generates a silhouette image from each of the two images. Next, the calculation unit 12 calculates the width of the above specific part from each of the two silhouette images that have been generated. Furthermore, the calculation unit 12 collates the calculated widths and the received gravity direction vector with the anatomical knowledge, calculates compensated coordinate values (x_{2′}, y_{2′}, z_{2′}), and provides the position compensation unit 14 with them. The compensated coordinate values (x_{2′}, y_{2′}, z_{2′}) are skeleton key point coordinate values used for compensating the skeleton key point coordinate estimation values (x₂, y₂, z₂) of the received specific part after rotation. The compensated coordinate values (x_{2′}, y_{2′}, z_{2′}) can be used for compensation as correct values of the skeleton key point coordinate estimation values (x₂, y₂, z₂) of each specific part in the image after rotation. The calculation method by the calculation unit 12 has been described in the first example embodiment, but an example of a specific calculation method after collation with the anatomical knowledge will be described later.

The position compensation unit 14 replaces the skeleton key point coordinate estimation values (x₂, y₂, z₂) of each specific part in the image after rotation with the compensated coordinate values (x_{2′}, y_{2′}, z_{2′}) of each specific part in the received image after rotation, and provides the output unit 13 with a replaced value. That is, the position compensation unit 14 compensates the position of the skeleton key point through such replacement. Thus, the position of the skeleton key point of each specific part in the image after rotation is compensated to a correct position.

In this manner, by including the position compensation unit 14, the processing apparatus 10 serves as an apparatus that compensates the skeleton key point coordinate estimation values, and thus the processing apparatus 10 can also be referred to as a key point compensation apparatus, a key point automatic compensation apparatus, or the like.

The output unit 13 outputs the compensated coordinate values (x_{2′}, y_{2′}, z_{2′}) for each specific part in the image after rotation to the feature calculation unit 103. In addition, the output unit 13 outputs, to the feature calculation unit 103, the skeleton key point coordinate estimation values of each specific part at the time of standing and the skeleton key point coordinate estimation values that have been received from the input unit 11 of another part in each of the two images at the time of standing and after rotation. The output unit 13 outputs all of these skeleton key point coordinate estimation values to the feature calculation unit 103, as values that does not have to be compensated, that is, as the correct skeleton key point coordinate values.

In this manner, regarding the image after rotation, the output unit 13 is also capable of outputting the compensated coordinate values for the specific part together with the skeleton key point coordinate estimation values of another part to the feature calculation unit 103. In addition, the output unit 13 is also capable of outputting, to the feature calculation unit 103, the skeleton key point coordinate estimation values of all the parts to be extracted including the specific part in the image at the time of standing. Note that as described above, the skeleton key point coordinate estimation values of each specific part at the time of standing and the skeleton key point coordinate estimation values of another part at the time of standing and after rotation are values of parts that are not to be compensated. Therefore, these skeleton key point coordinate estimation values can be handled without change as the skeleton key point coordinate values in the same manner as the skeleton key point coordinate values of each specific part after rotation. In this manner, the output unit 13 may output, to the feature calculation unit 103, a skeleton key point coordinate value group of each part at the time of standing and after rotation.

In addition, prior to the output to the feature calculation unit 103, it may inquire whether to compensate of the user. In this case, the compensated coordinate values that have been calculated by the calculation unit 12 are provided for the image generation unit 105, and the output unit 13 outputs the skeleton key point coordinate estimation values that have been received from the input unit 11 to the image generation unit 105, as the skeleton key point coordinate values. Then, the image generation unit 105 generates a user interface (UI) image for inquiring whether to compensate in such a manner of the user, causes the display unit 108 to displays the image, and receives an inquiry result from the operation unit 107.

Therefore, the image generation unit 105 may generate a compensation result display image, based on an extraction result and a compensation result of at least the skeleton key point coordinate values of each part after rotation, and may generate the above UI image to include the compensation result display image. Such a compensation result display image may include an image obtained by normalizing the two images or the image after rotation captured by the camera 101 or the two silhouette images or the silhouette image after rotation. In addition, the skeleton key point coordinate values obtained as the extraction result and the compensation result may be superimposed on the compensation result display image. Then, the UI image that has been generated by the image generation unit 105 is provided for the display unit 108, and the display unit 108 displays the UI image. The image generation unit 105 may output the generated UI image or the compensation result display image to another apparatus such as an external server or a terminal device via the communication unit 106.

The communication unit 106 communicates with another apparatus such as an external server or a terminal device. The communication unit 106 may include an antenna (not illustrated) for performing wireless communication, or may include an interface such as a network interface card (NIC) for performing wired communication.

The operation unit 107 receives an operation instruction from the user. The operation unit 107 is capable of receiving an instruction indicating whether to make compensation, as such an operation instruction. The operation unit 107 may be configured with a keyboard, or may be configured with a display device of a touch panel. The operation unit 107 may be configured with a keyboard or a touch panel connected to the main body of the rotation state recognition system 100.

The display unit 108 includes various display means such as a liquid crystal display (LCD) and a light emitting diode (LED). The display unit 108 displays the UI image that has been received from the image generation unit 105. That is, the display unit 108 is capable of displaying the compensated coordinate values, which are the skeleton key point coordinate values that have been calculated by the calculation unit 12 of the processing apparatus 10.

Then, the output unit 13 may output the skeleton key point coordinate values of the specific part and another part to the feature calculation unit 103 in response to the user operation for making the compensation from the operation unit 107.

In this manner, the output unit 13 may output the skeleton key point coordinate estimation values of the specific part after rotation together with the compensated coordinate values for the specific part after rotation to be included in the UI image displayed on the display device such as the display unit 108. Then, the UI image may include an image that receives a user operation for designating whether to make compensation by the position compensation unit 14. The image here denotes an image area for such designation. Such a user operation itself can be received by the operation unit 107. This enables the user to determine whether to make compensation while checking, with one or a plurality of UI images, the skeleton key point that has not been compensated and the skeleton key point that has been compensated. In such one or the plurality of UI images, the skeleton key point that has not been compensated and the skeleton key point that has been compensated may be displayed in an overlapping manner, or may be displayed separately together with each of the two images of the person or silhouette images. In a case where there are a plurality of skeleton key points to be compensated, it may be configured that only the skeleton key point that the user desires compensation in the UI image is selectable and correctable. This enables the user to compensate every skeleton key point in accordance with the user's preference. Further, the UI image may be displayed to emphasize a change due to the presence or absence of the compensation of the skeleton key point. For example, the skeleton key point after the compensation may be displayed in a more striking color or with a larger point than that of the skeleton key point group before the compensation.

Alternatively, the output unit 13 may only output the compensated coordinate values of the specific part after rotation to be included in the UI image displayed on the display device such as the display unit 108. Alternatively, the output unit 13 may only output the skeleton key point coordinate estimation values of the specific part at the time of standing and the compensated coordinate values for the specific part after rotation. In these cases, the skeleton key point coordinate estimation values of the above another part are not output.

Regarding the image at the time of standing as a first image and the image after rotation as a second image, the feature calculation unit 103 calculates one or a plurality of rotation features indicating the rotation state, based on the skeleton key point coordinate values of each part that have been received from the output unit 13, and extracts the rotation feature. Note that the feature calculation unit 103 can also be referred to as an extraction unit because it extracts a feature.

That is, the feature calculation unit 103 calculates the rotation feature, based on the compensated coordinate values of the specific part that have been output from the output unit 13 and the skeleton key point coordinate estimation values of the specific part at the time of standing, and another part at the time of standing and after rotation. Note that in FIG. 4 and the like, an example in which the feature calculation unit 103 is provided outside the processing apparatus 10 is given. However, it is needless to say, it possible to incorporate the feature calculation unit 103 into the processing apparatus 10. A calculation example of the rotation feature will be described later.

The state estimation unit 104 is used in an estimation phase that is an operation stage. The state estimation unit 104 estimates the rotation state of the object OBJ, based on one or a plurality of rotation features calculated by the feature calculation unit 103 using the state estimation model 112. The rotation state estimated by the state estimation unit 104 may be expressed by including a part of the rotation feature that has been calculated by the feature calculation unit 103 without change. However, it is possible to express it by including a value indicating the level of a rotation degree so that the object OBJ understands more easily. The state estimation unit 104 outputs an estimation result that has been obtained in this manner to the image generation unit 105. In addition, the state estimation unit 104 may output the estimation result that has been obtained in this manner to another apparatus via the communication unit 106.

Further, the image generation unit 105 is also capable of generating an estimation result display image to be displayed on the display unit 108, based on the estimation result that has been input from the state estimation unit 104, and generating a UI image to include the estimation result display image. In such an estimation result display image, it is possible to include an image obtained by normalizing the two images or the image after rotation captured by the camera 101, or the two silhouette images or the silhouette image after rotation. Then, the image generation unit 105 outputs the estimation result display image that has been generated to another apparatus such as an external server or a terminal device via the communication unit 106, or provides the display unit 108 with the generated UI image.

The display unit 108 displays the UI image including the estimation result display image that has been input from the image generation unit 105. That is, the display unit 108 may display at least a part of the result that has been estimated by the state estimation unit 104.

The learning unit 109 is used in the learning phase. The learning unit 109 performs the machine learning to generate the state estimation model 112, into which the rotation feature that has been calculated by the feature calculation unit 103 is input, and which outputs the rotation state of the object OBJ. The algorithm or the like of the state estimation model 112 is not limited, and, for example, a model using deep learning or the like is used.

The storage unit 110 stores the above-described skeleton extraction model 111, the state estimation model 112 that has been generated, and the like. Further, it is possible to include, in the storage unit 110, a nonvolatile memory (for example, read only memory (ROM)) in which various programs and various data necessary for processing are fixedly stored. Some or all of the functions of the skeleton extraction unit 102, the processing apparatus 10, the feature calculation unit 103, the state estimation unit 104, and the image generation unit 105 may be implemented as the above various programs. The above various programs are programs to be executed by a processor, not illustrated, of the rotation state recognition system 100. In addition, the storage unit 110 may use a hard disk drive (HDD) or a solid-state drive (SSD). Furthermore, it is possible to include, in the storage unit 110, a volatile memory such as a random access memory (RAM) used as a work area. The above various programs may be read from a portable recording medium such as an optical disk or a semiconductor memory, or may be downloaded from a server apparatus on a network.

### (Processing Example in Learning Phase in Rotation State Recognition System 100)

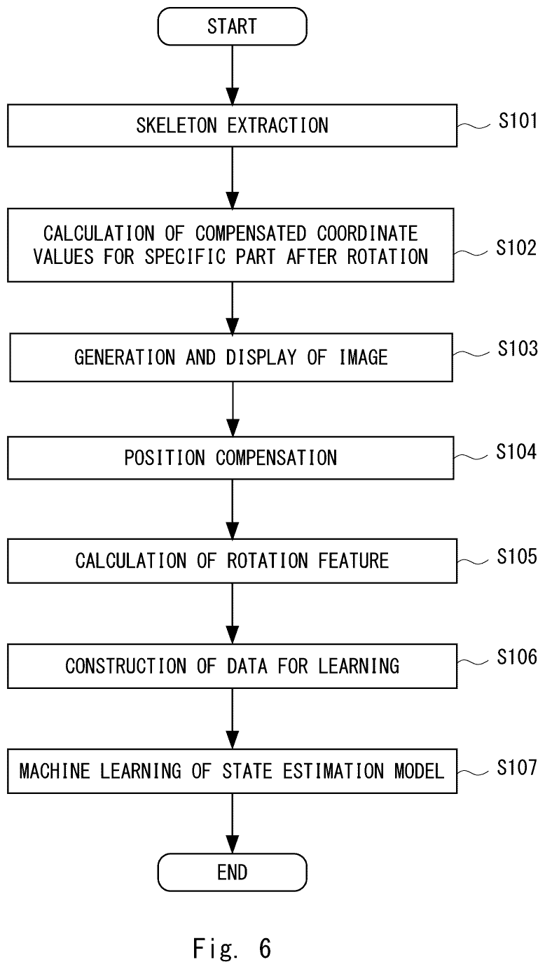

First, a processing example in the learning phase in the rotation state recognition system 100 will be described with reference to FIGS. 6 to 10. FIG. 6 is a flowchart for describing such a processing example.

The skeleton extraction unit 102 receives the moving image data MOV and the gravity direction vector from the camera 101, and designates a frame indicating an image at the time of standing and a frame indicating an image after rotation, as the above two images. Then, the skeleton extraction unit 102 inputs the two images that have been designated or the two images and the gravity direction vector into the skeleton extraction model 111, and obtains, as its output, the skeleton key point coordinate estimation values of a part to be extracted from each of the designated two images. In this manner, the skeleton extraction unit 102 extracts the skeleton (step S101). Accordingly, the skeleton key point coordinate estimation values (xᵢ, yᵢ, zᵢ) at the time of standing and the skeleton key point coordinate estimation values (xⱼ, yⱼ, zⱼ) after rotation are obtained. The part, which is to be extracted, of the object OBJ is not limited. However, in the following description, an example will be given in which left and right waist parts, shoulder parts, knee parts, and ankle parts are included as the specific part to be compensated, and these specific parts are included in the part to be extracted.

A method for extracting the skeleton key point coordinate estimation values is not limited to a specific method, but various methods including a method not using the skeleton extraction model 111 are applicable. Therefore, in such an extraction method, also in a case where the skeleton extraction model 111 is used, it does not depend on the type of the skeleton extraction model 111 to be used.

The skeleton extraction unit 102 provides the processing apparatus 10 with the two images at the time of standing and after rotation, the gravity direction vector, and the extracted skeleton key point coordinate estimation values (xᵢ, yᵢ, zᵢ) and (xⱼ, yⱼ, zⱼ) of each part at the time of standing and after rotation.

In the processing apparatus 10, the input unit 11 receives these images, the gravity direction vector, and these values, provides the calculation unit 12 with these images, the gravity direction vector, and the skeleton key point coordinate estimation values of the specific part after rotation, and provides the output unit 13 with the other ones. The calculation unit 12 generates two silhouette images, which are the respective silhouette images of the two images, and calculates the width of the specific part from these two silhouette images. The calculation unit 12 collates the calculated width and the gravity direction vector with the anatomical knowledge, and calculates compensated coordinate values (x_{2′}, y_{2′}, z_{2′}) of the skeleton key point coordinate estimation values (x₂, y₂, z₂) of the specific part after rotation (step S102).

Hereinafter, calculation examples of the compensated coordinate values for the specific part after rotation that have been collated with the anatomical knowledge will be individually described using left and right waist parts, shoulder parts, knee parts, and ankle parts given as examples of the specific part.

### [Compensation Example of Key Point of Waist Part]

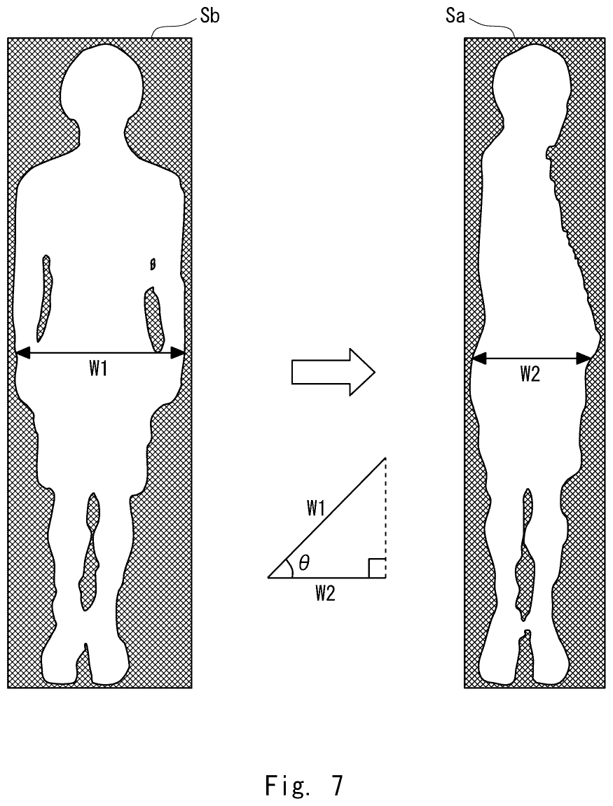

FIG. 7 illustrates a schematic view of a compensation example of the key point of the waist part together with a silhouette image Sb at the time of standing and a silhouette image Sa after rotation, which are two silhouette images. The silhouette image of the object OBJ changes from the silhouette image Sb in the standing state to the silhouette image Sa in accordance with a rotation motion. In this example, it is assumed that the specific part includes left and right waists, that is, left and right waist parts. The left and right waist parts are respectively expressed by coordinate values of key points of the left waist and the right waist. That is, the skeleton key point coordinate estimation values to be input include the skeleton key point coordinate estimation values of the left and right waists.

The calculation unit 12 calculates a width between the left and right waists, that is, the waist width as the width of the specific part from each the silhouette image Sb at the time of standing and the silhouette image Sa after rotation. In FIG. 7, a calculated left and right waist width at the time of standing is indicated by W1, and a calculated left and right waist width after rotation is indicated by W2.

Next, the calculation unit 12 calculates compensated coordinate values (x₂′, y_{2′}, z_{2′}) of the left and right waits as positions having a waist rotation angle that has been inversely calculated from the ratio of the waist widths W1 and W2 in the two silhouette images Sb and Sa that have been calculated in a plane orthogonal to the gravity direction vector. The above ratio can indicate a ratio after rotation relative to the time of standing or its inverse number. The compensated coordinate values (x_{2′}, y_{2′}, z_{2′}), to be calculated, of the left waist and the right waist are respectively compensated coordinate values of the skeleton key point coordinate estimation values (x₂, y₂, z₂) of the left waist and the right waist in the image after rotation.

More specifically, the calculation unit 12 calculates a waist width W1 of the silhouette image Sb and a waist width W2 of the silhouette image Sa in each of the images at the time of standing and after rotation, for example, on a plane indicated by the median value of the skeleton key point coordinate estimation values of the left and right waists in each of the above images. Then, the calculation unit 12 calculates a waist rotation angle θ, which satisfies the relationship illustrated in FIG. 7. The waist rotation angle θ is a value indicating a rotation angle of the waist with respect to the ground, and θ=cos⁻¹(W2/W1).

Next, the calculation unit 12 rotates the vector from the left waist to the right waist in the standing pose by the waist rotation angle θ around the gravity direction in the plane orthogonal to the gravity direction indicated by the gravity direction vector. The vector before rotation is a vector indicated by the skeleton key point coordinate estimation values (x₂, y₂, z₂) of the left waist and the right waist in the image after rotation.

Then, the calculation unit 12 arranges the vector obtained by the rotation on the frame indicating the pose after rotation, that is, on the image after rotation so that the midpoint of the vector coincides with the waist central coordinate values that have been estimated for the pose after rotation. Here, it is possible to calculate the waist central coordinate values as a median value of the skeleton key point coordinate estimation values (x₂, y₂, z₂) for the left waist and the right waist in the image after rotation. Finally, the calculation unit 12 calculates each end point of the vector arranged on the image after rotation as the coordinate values of the left waist and the coordinate values of the right waist after rotation. The coordinate values of the left waist and the coordinate values of the right waist that have been calculated in this manner respectively correspond to the compensated coordinate values (x_{2′}, y_{2′}, z_{2′}) of the left waist and the right waist.

In this manner, the calculation unit 12 obtains the compensated coordinate values of the skeleton key point coordinate estimation values (x₂, y₂, z₂) of the left and right waist parts of the image after rotation, out of the skeleton key point coordinate estimation values (x₁, y₁, z₁) and (x₂, y₂, z₂) of the left and right waist parts of the two images.

In addition, the calculation unit 12 may calculate the compensated coordinate values (x_{2′}, y_{2′}, z_{2′}) of the left waist and the right waist in consideration of the thickness of the waist part in the same manner as a method for calculating the compensated coordinate values (x_{2′}, y_{2′}, z_{2′}) of the left shoulder and the right shoulder to be described later. In this case, although the details are omitted, it is sufficient to calculate the waist rotation angle θ using an equation to be described later as an equation for obtaining a rotation angle of the trunk in the method for calculating the shoulder, and to rotate the vector using the waist rotation angle θ that has been calculated.

### [Compensation Example of Key Point of Shoulder Part]

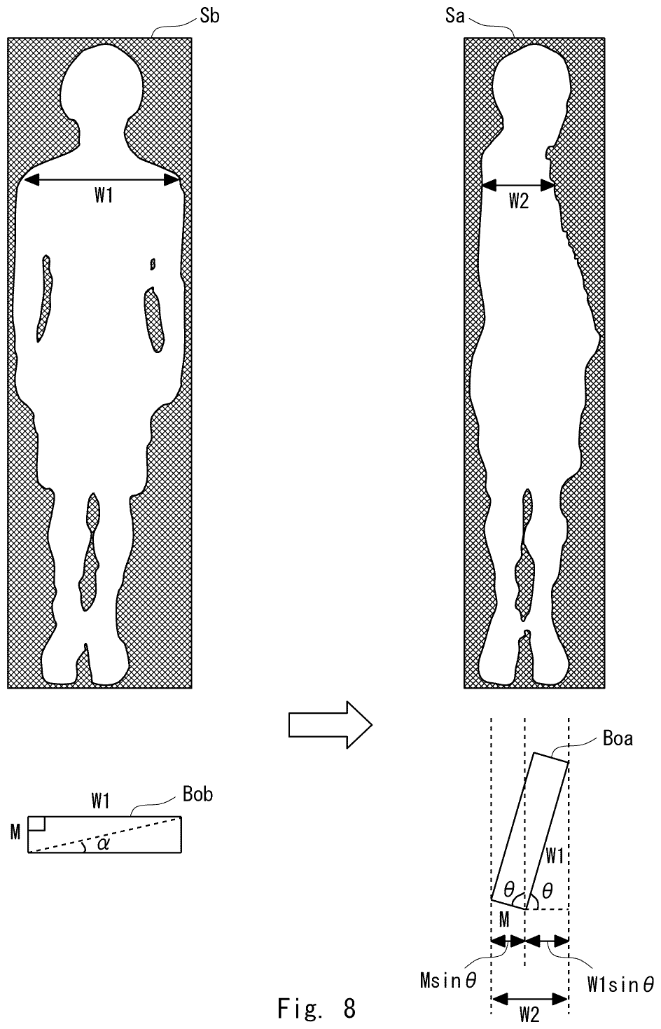

FIG. 8 illustrates a schematic view of a compensation example of the key point of the shoulder part together with the silhouette image Sb at the time of standing and the silhouette image Sa after rotation. In this example, it is assumed that the specific part includes left and right shoulders, that is, left and right shoulder parts. The left and right shoulder parts are respectively expressed by coordinate values of key points of the left shoulder and the right shoulder. That is, the skeleton key point coordinate estimation values to be input include the skeleton key point coordinate estimation values of the left and right shoulders.

The calculation unit 12 calculates the width between the left and right shoulders, that is, the shoulder width as the width of the specific part from each of the silhouette image Sb at the time of standing and the silhouette image Sa after rotation, which are two silhouette images. In FIG. 8, a calculated shoulder width at the time of standing is indicated by W1, and a calculated shoulder width after rotation is indicated by W2.

Next, the calculation unit 12 calculates compensated coordinate values (x_{2′}, y_{2′}, z_{2′}) of the left and right shoulders as the positions having a shoulder rotation angle that has been inversely calculated from the ratio of the shoulder widths W1 and W2 of the two silhouette images Sb and Sa that have been calculated in the plane orthogonal to the gravity direction vector. The compensated coordinate values (x_{2′}, y_{2′}, z_{2′}), to be calculated, of the left shoulder and the right shoulder are respectively compensated coordinate values of the skeleton key point coordinate estimation values (x₂, y₂, z₂) of the left shoulder and the right shoulder in the image after rotation.

More specifically, the calculation unit 12 calculates a shoulder width W1 of the silhouette image Sb and a shoulder width W2 of the silhouette image Sa in each of the images at the time of standing and after rotation, for example, on a plane indicated by the median value of the skeleton key point coordinate estimation values of the left and right shoulders in each of the above images. Such a plane may include, for example, coordinate values lower in the vertical direction by a predetermined percentage of the height from the skeleton key point coordinate estimation values of a predetermined cervical vertebra in each of the above images or the skeleton key point coordinate estimation values of the cervical vertebra.

Then, the calculation unit 12 calculates a shoulder rotation angle θ, which satisfies the relationship illustrated in a schematic diagram Boa in FIG. 8. In FIG. 8, a schematic diagram Bob is a diagram illustrating a state of the trunk in a case where the standing pose is viewed from directly above, and the schematic diagram Boa is a diagram illustrating a state of the trunk in a case where the pose after rotation is viewed from directly above. The shoulder rotation angle θ is a value indicating a rotation angle of the shoulder with respect to the ground, and here, an example of obtaining the shoulder rotation angle θ as a rotation angle of the trunk with respect to the ground is given, without being limited to this. Here, a thickness M of the trunk may be set to a value obtained by a predetermined calculation equation, for example, a value of 40% of W1. The shoulder rotation angle θ is obtained by a relational equation W2=W1cosθ+Msinθ=(cos(θ−a)×√(W1²+M²), which is illustrated in the schematic diagram Boa. That is, the shoulder rotation angle θ satisfies that θ=cos⁻¹(W2/√(W1²+M²))+cos⁻¹(W1/√(W1²+M²)).

Next, the calculation unit 12 rotates the vector from the left shoulder to the right shoulder in the standing pose by the rotation angle θ around the gravity direction in the plane orthogonal to the gravity direction indicated by the gravity direction vector. The vector before rotation is a vector indicated by the skeleton key point coordinate estimation values (x₂, y₂, z₂) of the left shoulder and the right shoulder in the image after rotation.

Then, the calculation unit 12 arranges the vector obtained by the rotation on the frame indicating the pose after rotation, that is, on the image after rotation so that the midpoint of the vector coincides with the near-side shoulder coordinate values that have been estimated for the pose after rotation. Here, since the near-side shoulder coordinate value is a value that has been estimated from the captured image, the near-side shoulder coordinate values are referred to as coordinate values of the near-side shoulder, the image of which has been captured. Finally, the calculation unit 12 calculates each end point of the vector arranged on the image after rotation as the coordinate values of the left shoulder and the coordinate values of the right shoulder after rotation. The coordinate values of the left shoulder and the coordinate values of the right shoulder that have been calculated in this manner respectively correspond to the compensated coordinate values (x_{2′}, y_{2′}, z_{2′}) of the left shoulder and the right shoulder.

In this manner, the calculation unit 12 obtains the compensated coordinate values of the skeleton key point coordinate estimation values (x₂, y₂, z₂) of the left and right shoulder parts of the image after rotation, out of the skeleton key point coordinate estimation values (x₁, y₁, z₁) and (x₂, y₂, z₂) of the left and right shoulder parts of the two images.

### [Compensation Example of Key Point of Knee]

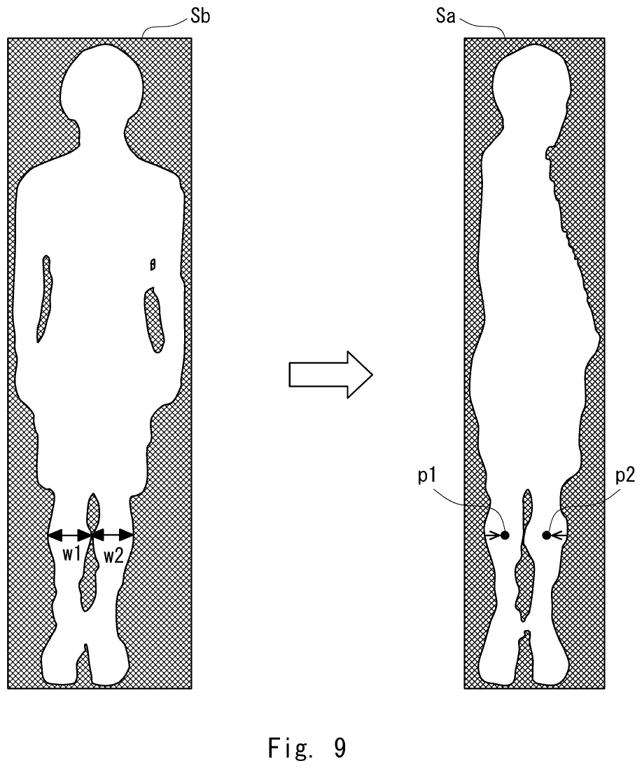

FIG. 9 illustrates a schematic view of a compensation example of the key point of the knee together with the silhouette image Sb at the time of standing and the silhouette image Sa after rotation. In this example, it is assumed that the specific part includes left and right knees, that is, left and right knee parts. The left and right knee parts are respectively expressed by coordinate values of key points of the left knee and the right knee. That is, the skeleton key point coordinate estimation values to be input include the skeleton key point coordinate estimation values of the left and right knees.

The calculation unit 12 calculates widths of the left and right knees, that is, knee widths of the left and right knees from the silhouette image Sb at the time of standing, out of the silhouette image Sb at the time of standing and the silhouette image Sa after rotation. In FIG. 9, a calculated knee width of the right leg at the time of standing is indicated by w1, and a calculated knee width of the left leg at the time of standing is indicated by w2.

Next, the calculation unit 12 calculates positions respectively shifted inward in the silhouette image Sa after rotation from edges of the silhouette image Sa after rotation by lengths respectively proportional to the calculated left and right knee widths w2 and w1, in a plane orthogonal to the gravity direction vector. The calculation unit 12 calculates these positions as the compensated coordinate values (x_{2′}, y_{2′}, z_{2′}) of the left and right knees. The compensated coordinate values (x_{2′}, y_{2′}, z_{2′}), to be calculated, of the left knee and the right knee are respectively compensated coordinate values of the skeleton key point coordinate estimation values (x₂, y₂, z₂) for the left knee and the right knee in the image after rotation.

More specifically, the calculation unit 12 calculates the right knee width w1 and the left knee width w2 of the silhouette image Sb at the time of standing, for example, on a plane indicated by the skeleton key point coordinate estimation values of the left and right knees in the image at the time of standing. Then, the calculation unit 12 calculates the total value w in accordance with an equation w=w1+w2.

The calculation unit 12 calculates coordinate values of points p1 and p2, which are respectively shifted inward in the silhouette by w/4 in the plane orthogonal to the gravity direction indicated by the gravity direction vector from both points of edges respectively corresponding to the outer sides of the left and right legs in the silhouette image Sa in the plane indicated by the left and right knee coordinates in the pose after rotation. Here, the plane indicated by the left and right knee coordinates in the pose after rotation indicates the plane indicated by the skeleton key point coordinate estimation values of each of the left and right knees. Note that the edge corresponding to the outer side of the left leg denotes an edge corresponding to the left side surface of the left leg, and the edge corresponding to the outer side of the right leg denotes an edge corresponding to the right side surface of the right leg. The calculation unit 12 calculates the coordinate values of the points p1 and p2 as the respective coordinate values of the right knee and the left knee of the pose after rotation. Note that in the silhouette image Sa in FIG. 9, lengths of lines indicated by arrows toward the points p1 and p2 are each w/4. The coordinate values of the left knee and the coordinate values of the right knee that have been calculated in this manner respectively correspond to the compensated coordinate values (x_{2′}, y_{2′}, z_{2′}) of the left knee and the right knee.

In this manner, the calculation unit 12 obtains the compensated coordinate values of the skeleton key point coordinate estimation values (x₂, y₂, z₂) of the left and right knee parts of the image after rotation, out of the skeleton key point coordinate estimation values (x₁, y₁, z₁) and (x₂, y₂, z₂) of the left and right knee parts of the two images.

### [Compensation Example of Key Point of Ankle]

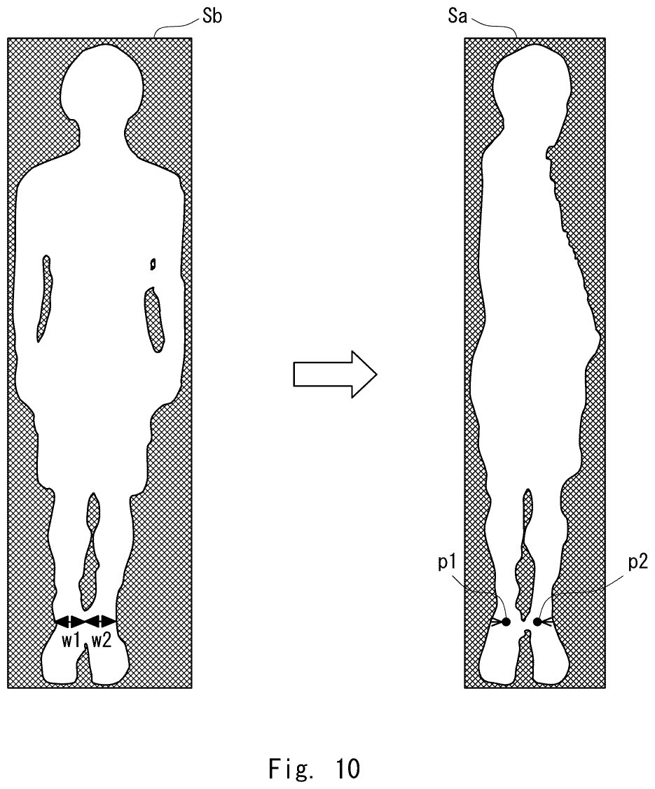

FIG. 10 illustrates a schematic view of a compensation example of the key point of an ankle together with the silhouette image Sb at the time of standing and the silhouette image Sa after rotation. In this example, it is assumed that the specific part includes left and right ankles, that is, left and right ankle parts. The left and right ankle parts are respectively expressed by coordinate values of key points of the left ankle and the right ankle. That is, the skeleton key point coordinate estimation values to be input include the skeleton key point coordinate estimation values of the left and right ankles.

The calculation unit 12 calculates widths of the left and right ankles, that is, ankle widths of the left and right ankles from the silhouette image Sb at the time of standing, out of the silhouette image Sb at the time of standing and the silhouette image Sa after rotation. In FIG. 10, a calculated ankle width of the right leg at the time of standing is indicated by w1, and a calculated ankle width of the left leg at the time of standing is indicated by w2.

Next, the calculation unit 12 calculates positions respectively shifted inward in the silhouette image Sa after rotation from edges of the silhouette image Sa after rotation by lengths respectively proportional to the calculated left and right ankle widths w1 and w2, in a plane orthogonal to the gravity direction vector. The calculation unit 12 calculates these positions as the compensated coordinate values (x_{2′}, y_{2′}, z_{2′}) of the left and right ankles. The compensated coordinate values (x_{2′}, y_{2′}, z_{2′}), to be calculated, of the left ankle and the right ankle are respectively compensated coordinate values of the skeleton key point coordinate estimation values (x₂, y₂, z₂) for the left ankle and the right ankle in the image after rotation.

More specifically, the calculation unit 12 calculates the right ankle width w1 and the left ankle width w2 of the silhouette image Sb at the time of standing, for example, on a plane indicated by the skeleton key point coordinate estimation values of the left and right ankles in the image at the time of standing. Then, the calculation unit 12 calculates the total value w in accordance with an equation w=w1+w2.

The calculation unit 12 calculates coordinate values of points p1 and p2, which are respectively shifted inward in the silhouette by w/4 in the plane orthogonal to the gravity direction indicated by the gravity direction vector from both points of edges respectively corresponding to the outer sides of the left and right legs in the silhouette image Sa in the plane indicated by the left and right ankle coordinates in the pose after rotation. Here, the plane indicated by the left and right ankle coordinates in the pose after rotation indicates the plane indicated by the skeleton key point coordinate estimation values of each of the left and right ankles. The calculation unit 12 calculates the coordinate values of the points p1 and p2 as the respective coordinate values of the right ankle and the left ankle of the pose after rotation. Note that in the silhouette image Sa in FIG. 10, lengths of lines indicated by arrows toward the points p1 and p2 are each w/4. The coordinate values of the left ankle and the coordinate values of the right ankle that have been calculated in this manner respectively correspond to the compensated coordinate values (x_{2′}, y_{2′}, z_{2′}) of the left ankle and the right ankle.

In this manner, the calculation unit 12 obtains the compensated coordinate values of the skeleton key point coordinate estimation values (x₂, y₂, z₂) of the left and right ankle parts of the image after rotation, out of the skeleton key point coordinate estimation values (x₁, y₁, z₁) and (x₂, y₂, z₂) of the left and right ankle parts of the two images.

### [Supplement to Compensation Example About Key Point of Specific Part After Rotation]

In compensating the key point of the above-described specific part after rotation, that is, the specific part in the rotation pose, the following various application examples ae applicable.

In a case where the waist width W1 is calculated from the silhouette image Sb or in a case where the waist width W2 is calculated from the silhouette image Sa, there is a possibility that the thicknesses of the left and right hands might also be included in the waist width. Therefore, in such a case, by separating the hands and the waist part in both the silhouette image Sb and the silhouette image Sa using the segmentation technique for each part of the body, it becomes possible to calculate only the waist width accurately. Note that as the segmentation technique, for example, the following one can be given as an example, but various techniques are applicable without being limited to this.
<https://blog.tensorflow.org/2019/11/updated-bodypix-2.html>

As a method for calculating the thickness M of the trunk, the following method is adoptable. That is, an image obtained by image capturing the standing pose from beside and the skeleton key point coordinate estimation values corresponding to it are obtained, so that the thickness M can be calculated as the width at the position of the neck coordinates in the silhouette image.

Regarding input information into the processing apparatus 10, in compensating the key point of the shoulder or the waist, even though the image is not captured in a state in which the imaging plane of the camera 101 and the frontal plane of the object OBJ are accurately parallel to each other, it is sufficient if the angle formed by them is smaller than 90 degrees. Satisfying this condition means that the shoulder width and the waist width are determined as positive values in the standing pose. It is needless to say that even though the image is not captured in the state in which the imaging plane of the camera 101 and the frontal plane of the object OBJ are accurately parallel to each other, processing for the compensation of the key points of the knee and the ankle can be performed because the plane orthogonal to the gravity direction is determined by the processing using the gravity direction vector.

Heretofore, step S102 has been described. Subsequently to step S102, in order to inquire the user of whether to compensate, the image generation unit 105 generates a UI image, and the display unit 108 displays the UI image (step S103).

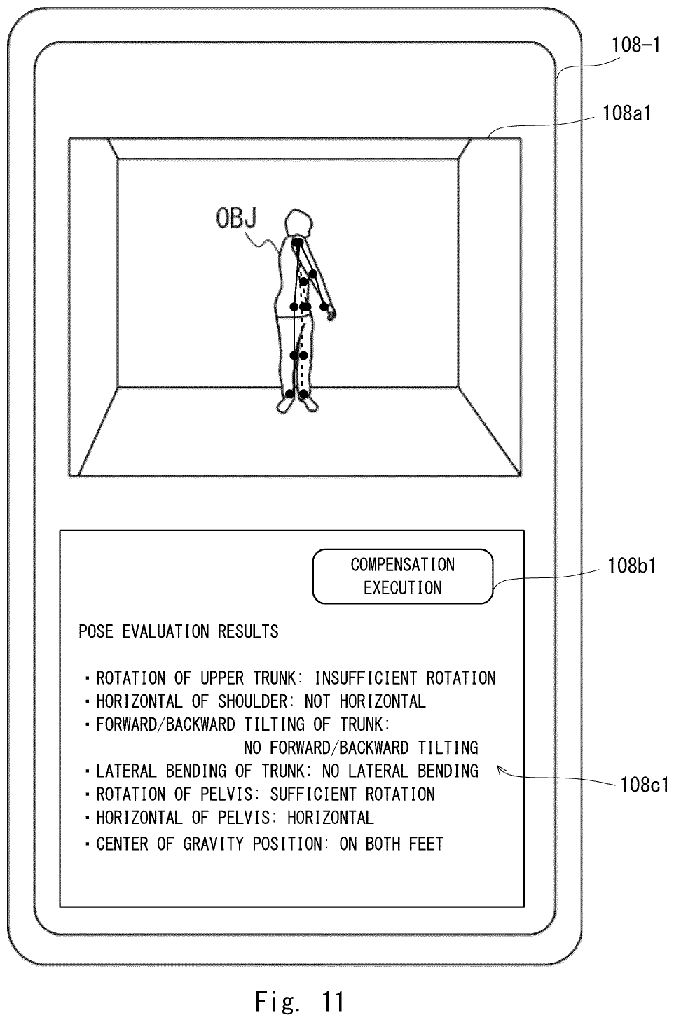

Such a UI image can include, for example, like a UI image 108-1 illustrated in FIG. 11, an image 108a1 after the object OBJ twists or its silhouette image, marks indicating the skeleton key point coordinate estimation values superimposed on the image, and a compensation execution button 108b1. In addition, as illustrated in FIG. 11, the skeleton of the object OBJ can be easily seen by drawing a line connecting the marks. The marks and lines superimposed on the image 108a1 are drawn, based on the skeleton key point coordinate estimation values that have been extracted for each part by the skeleton extraction unit 102, that is, based on the position of the uncompensated skeleton key point.

The compensation execution button 108b1 is a button selectable by the user using the operation unit 107, and is a button for displaying a result of compensation of the position, that is, compensation for a specific part of the skeleton key point coordinate estimation values. The compensation execution button 108b1 switches the key point to compensated coordinate values, and thus can also be referred to as a key point switching button.

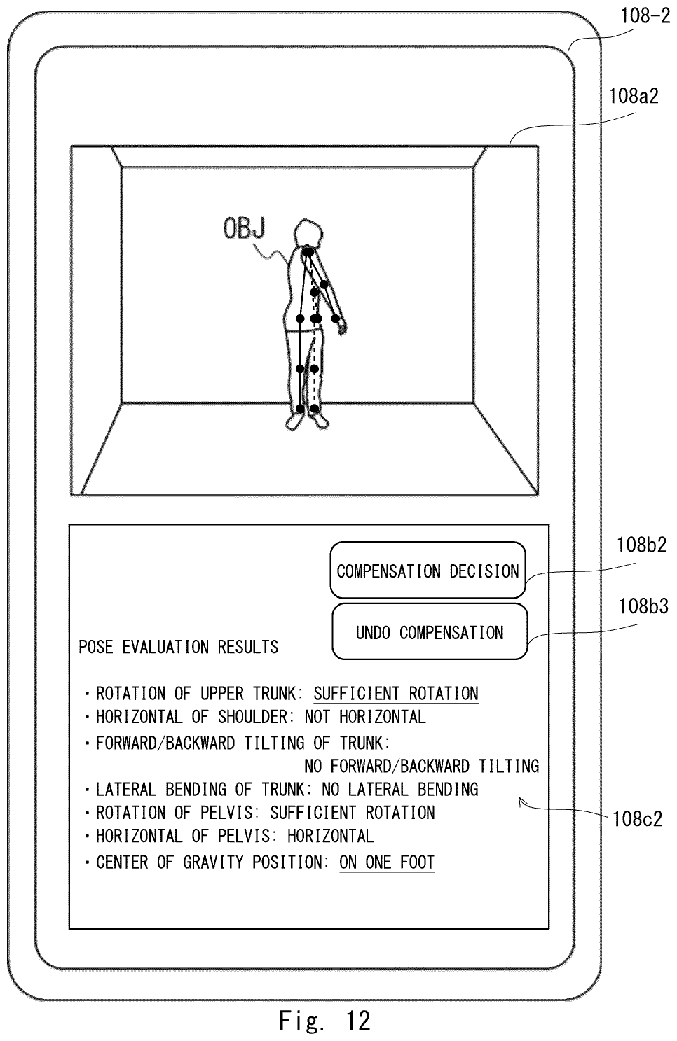

In a case where the user selects the compensation execution button 108b1 using the operation unit 107, a UI image that reflects such compensation can be displayed as a UI image 108-2 illustrated in FIG. 12. The UI image 108-2 is an example of the above-described compensation result display image. In this case, before the user selects the compensation execution button 108b1 or in a case where the compensation execution button 108b1 is selected, the position compensation in step S104 to be described later is provisionally conducted. As a result, the marks and lines superimposed on the image 108a1 change to the marks and lines superimposed on the image 108a2 in the UI image 108-2. The marks and lines superimposed on the image 108a2 are drawn, based on the compensated coordinate values for the specific part after rotation and the skeleton key point coordinate estimation values that have been extracted for each part by the skeleton extraction unit 102 of another part.

Furthermore, in the UI image 108-2, instead of the compensation execution button 108b1, an execution decision button 108b2 for deciding the compensation and a button 108b3 for undoing the compensation are displayed in a user selectable manner.

In addition, the compensation execution button 108b1 is a button for performing an operation of collectively compensating the specific part after rotation of a calculation target to the compensated coordinate values. However, without being limited to this, a UI image in which it is possible to designate the presence or absence of the execution of compensation may be displayed for each of the concerned specific parts.

Further, as illustrated in FIG. 11, the UI image 108-1 can also include information 108c1, which indicates pose evaluation results. The information 108c1 can include, for example, information indicating whether rotation of the upper trunk is sufficient or insufficient, information indicating whether or not the shoulder is horizontal, information indicating whether presence or absence of the trunk tilted forward/backward, and information indicating presence or absence of lateral bending of the trunk. In addition, the information 108c1 can also include information indicating whether rotation of the pelvis is sufficient or insufficient, information indicating whether or not the pelvis is horizontal, information indicating whether the center of gravity position is located on both legs or one leg, and the like.

However, here, the processing is performed in the learning phase of the state estimation model 112, and thus the information 108c1 may not be necessarily displayed. On the other hand, as illustrated in FIG. 11, in a case where the information 108c1 is displayed also in the learning phase, it is necessary to obtain the pose evaluation results. In this case, before the UI image 108-1 is generated, the rotation feature in step S105 to be described later is provisionally calculated for the skeleton key point coordinate estimation value group before compensation. Then, the rotation state may be estimated, based on the rotation feature that has been calculated, and an estimation result may be displayed. For example, the state estimation unit 104 may estimate the rotation state with a simple state estimation model having the same input and output information with the state estimation model 112 or the state estimation model 112 in the middle of learning, based on the rotation feature that has been calculated, and provides the image generation unit 105 with the estimation result as the pose evaluation result. It is also possible to estimate the rotation state using a simple state estimation program instead of a machine learned model like the state estimation model. The image generation unit 105 may generate the information 108c1 based on the estimation result that has been received, and may provide the display unit 108 with the information, and the display unit 108 may display the information 108c1 included in the UI image 108-1.

In addition, it is also possible to include information 108c2 indicating the pose evaluation results in the UI image 108-2 illustrated in FIG. 12. In this case, before the user selects the compensation execution button 108b1 or in response to the compensation execution button 108b1 is selected, the rotation feature in step S105 to be described later is provisionally calculated for the skeleton key point coordinate value group that reflects the compensation. Note that the skeleton key point coordinate value group that reflects the compensation includes the compensated coordinate values for the specific part after rotation, the skeleton key point coordinate estimation values of the specific part at the time of standing, and the skeleton key point coordinate estimation values of another part at the time of standing and after rotation. Then, the rotation state may be estimated, based on the rotation feature that has been calculated, and an estimation result may be displayed. The procedure of displaying the information 108c2 is similar to the procedure of displaying the information 108c1.

Further, in generating the UI image 108-2, the image generation unit 105 may compare the information 108c1 with the information 108c2 or compare marks and lines before and after compensation, so that a mark or a line indicating a compensated key point or a pose evaluation result that has been changed by the compensation may be displayed in a highlighted manner. In the example of FIG. 12, only the pose evaluation results that have been changed from before the compensation are highlighted with underlines. However, the example of highlighting is not limited to this, and it is also possible to highlight a mark or a line superimposed on the image 108a2 by changing a mark type or a line type.

In a case where the user selects the compensation decision button 108b2 from the operation unit 107 to input an instruction of position compensation, the position compensation unit 14 performs position compensation in accordance with such an instruction (step S104). By this position compensation, also on the actual data used in the subsequent processing, the skeleton key point coordinate estimation value group that has been exemplified with the mark superimposed on the image 108a1 is compensated to the skeleton key point coordinate value group exemplified with the mark superimposed on the image 108a2 to be provided for the output unit 13.

Then, the output unit 13 may output the skeleton key point coordinate values of the specific part and another part to the feature calculation unit 103 in response to the user operation for the compensation from the operation unit 107, in this manner. That is, the output unit 13 outputs the compensated coordinate values for the specific part after rotation as correct skeleton key point coordinate values to the feature calculation unit 103, and also outputs the remaining skeleton key point coordinate estimated values as the correct skeleton key point coordinate values to the feature calculation unit 103. On the other hand, in a case where the user selects the button 108b3 for undoing the compensation from the operation unit 107, the output unit 13 may output, to the feature calculation unit 103, the skeleton key point coordinate estimation value group exemplified with the mark superimposed on the image 108a1 without change as the skeleton key point coordinate value group.

In addition, the UI image 108-1 and the UI image 108-2 may be included in the same UI image to be displayed at the same time. This enables the user to visually recognize the information before and after the compensation at a time, which is useful. In addition, the UI image 108-1 and the UI image 108-2 both include only the information after rotation, but may also include information at the time of standing.

Heretofore, steps S103 to S104 have been described. Subsequently to step S104, the feature calculation unit 103 calculates a rotation feature based on the skeleton key point coordinate value group of each part at the time of standing and after rotation that has been received from the output unit 13 (step S105). As described above, in a case where the calculation has been provisionally completed, the calculation result may be adopted as a formal calculation result.

In step S105, the feature calculation unit 103 extracts a rotation feature indicating the motion state of a part to be analyzed of the object OBJ, who is a learning target before and after rotation, that is, the rotation state, based on the skeleton key point coordinate value group of each part that has been received. As described above, the rotation feature denotes a feature indicating the rotation state of a rotation motion between at the time of standing and after rotation of the object OBJ.

Hereinafter, an example in which the feature calculation unit 103 calculates the following ten types of rotation features F0 to F9 will be described. However, for example, it is possible to calculate a rotation feature in consideration of the value of a knee, an ankle, or the like and the rotation feature of a knee, an ankle, or the like, which are not illustrated.

In addition, in calculating the rotation feature, two frames temporally separated from the moving image are selected as images at the time of standing and after rotation, and the rotation feature of the part to be analyzed of the object OBJ, who is a learning target, between these two frames is calculated. Hereinafter, out of two temporally separated frames, a frame at the time of standing, which is a temporally former frame, will be referred to as a former frame, and a frame after rotation, which is a temporally later frame, will be referred to as a later frame.

Regarding the rotation feature, for example, a displacement of the position of a skeleton key point, that is, the skeleton key point coordinate values can be expressed as an angular displacement of a vector connecting the skeleton key points between two frames.

### [F0: Acromion Rotation Amount]

In the upper trunk, a feature indicating a rotation amount of a line that connects the left shoulder L1 with the right shoulder R1 with respect to the midline of the object OBJ is defined as an acromion rotation amount F0. Hereinafter, calculation of the acromion rotation amount FO will be described.

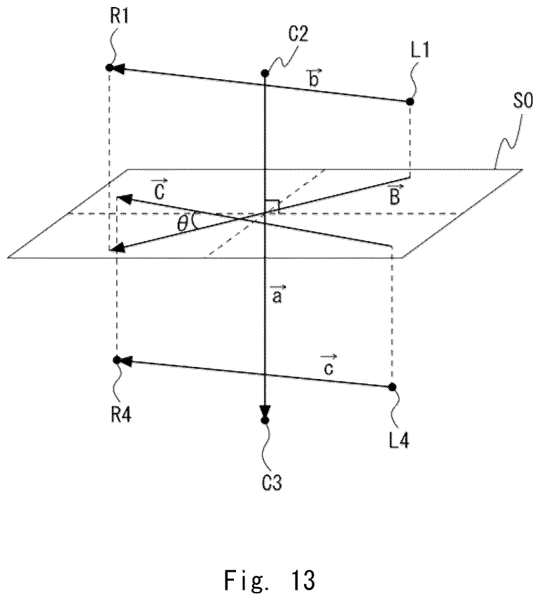

The following calculation is performed for each frame. FIG. 13 illustrates an outline of the calculation of the acromion rotation amount in each frame. First, a plane S0, which is orthogonal to a vector a from the neck C2 to the waist center C3 is fixed. Next, an angle θ, which is formed by a vector B obtained by projecting a vector b from the left shoulder L1 to the right shoulder R1 onto the plane S0 and a vector C obtained by projecting a vector c from the left waist L4 to the right waist R4 onto the plane SO, is calculated. Note that in the following description, θ_{L} denotes the angle that has been calculated from the later frame, and θ_{F} denotes the angle that has been calculated from the former frame.

Then, a difference Δθ, which is obtained by subtracting the angle θ_{F} calculated in the former frame from the angle θ_{L} calculated in the later frame, is calculated as the acromion rotation amount F0.

### [F1: Left Upper Arm Separation]

In a case where the body is twisted to the right or left, how far the left upper arm is separated from the upper trunk, that is, a feature indicating a compensatory motion by the left upper arm is defined as left upper arm separation F1. Hereinafter, calculation of the left upper arm separation F1 will be described.

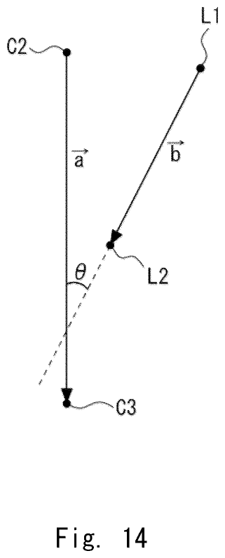

The following calculation is performed for each frame. FIG. 14 illustrates an outline of the calculation of the left upper arm separation in each frame. First, a vector a from the neck C2 to the waist center C3 and a vector b from the left shoulder L1 to the left elbow L2 are generated, and an angle θ formed by these vectors is calculated.

Then, a difference Δθ, which is obtained by subtracting the angle θ_{F} calculated in the former frame from the angle θ_{L} calculated in the later frame, is calculated as the left upper arm separation F1.

### [F2: Right Upper Arm Separation]

In a case where the body is twisted to the right or left, how far the right upper arm is separated from the upper trunk, that is, a feature indicating a compensatory motion by the right upper arm is defined as right upper arm separation F2. Hereinafter, calculation of the right upper arm separation F2 will be described.

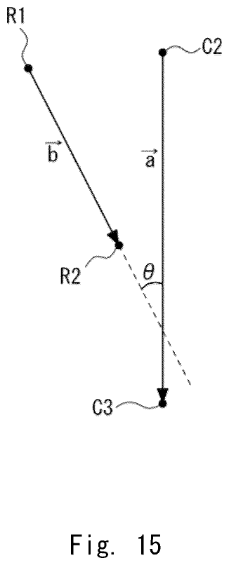

The following calculation is performed for each frame. FIG. 15 illustrates an outline of the calculation of the right upper arm separation in each frame. First, a vector a from the neck C2 to the waist center C3 and a vector b from the right shoulder R1 to the right elbow R2 are generated, and an angle θ formed by these vectors is calculated.

Then, a difference Δθ, which is obtained by subtracting the angle θ_{F} calculated in the former frame from the angle θ_{L} calculated in the later frame, is calculated as the right upper arm separation F2.

### [F3: Left Lower Arm Bending]

In a case where the body is twisted to the right or left, how the arm from the left elbow to the tip bends, that is, the feature indicating a compensatory motion by the left lower arm is defined as left lower arm bending F3. Hereinafter, calculation of the left lower arm bending F3 will be described.

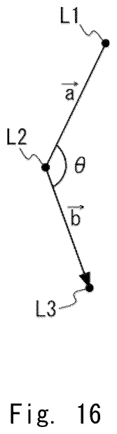

The following calculation is performed for each frame. FIG. 16 illustrates an outline of the calculation of the left lower arm bending in each frame. First, a vector a from the left shoulder L1 to the left elbow L2 and a vector b from the left elbow L2 to the left wrist L3 are generated, and an angle θ formed by these vectors is calculated.

Then, a difference Δθ, which is obtained by subtracting the angle OF calculated in the former frame from the angle θ_{L} calculated in the later frame, is calculated as the left lower arm bending F3.

### [F4: Right Lower Arm Bending]

In a case where the body is twisted to the right or left, how the arm from the right elbow to the tip bends, that is, the feature indicating a compensatory motion by the right lower arm is defined as right lower arm bending F4. Hereinafter, calculation of the right lower arm bending F4 will be described.

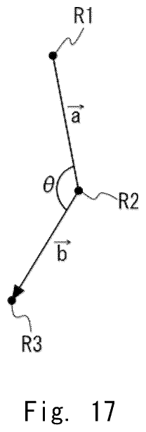

The following calculation is performed for each frame. FIG. 17 illustrates an outline of the calculation of right lower arm bending in each frame. First, a vector a from the right shoulder R1 to the right elbow R2 and a vector b from the right elbow R2 to the right wrist R3 are generated, and an angle θ formed by these vectors is calculated.

Then, a difference Δθ, which is obtained by subtracting the angle θ_{F} calculated in the former frame from the angle θ_{L} calculated in the later frame, is calculated as the right lower arm bending F4.

### [F5: The Horizontal of Acromion]

The feature indicating the inclination of a line that connects the right shoulder R1 with the left shoulder L1 with respect to the upper trunk is defined as the horizontal of acromion F5. Hereinafter, calculation of the horizontal of acromion F5 will be described.

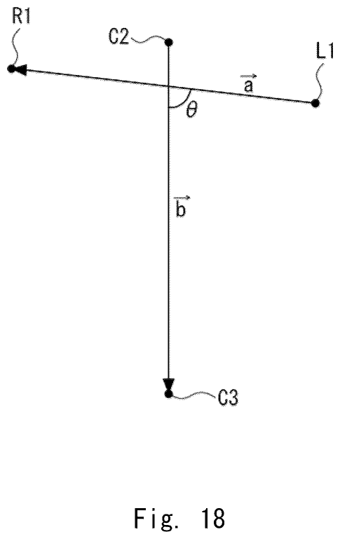

The following calculation is performed for each frame. FIG. 18 illustrates an outline of the calculation of the horizontal of acromion in each frame. First, a vector a from the left shoulder L1 to the right shoulder R1 and a vector b from the neck C2 to the waist center C3 are generated, and an angle θ formed by these vectors is calculated.

Then, a difference Δθ, which is obtained by subtracting the angle θ_{F} calculated in the former frame from the angle θ_{L} calculated in the later frame, is calculated as the horizontal of acromion F5.

### [F6: Upper Trunk Frontward/Backward Tilting]

A feature indicating forward/backward tilting of the upper trunk is defined as an upper trunk forward/backward tilting F6. Hereinafter, calculation of the upper trunk forward/backward tilting F6 will be described.

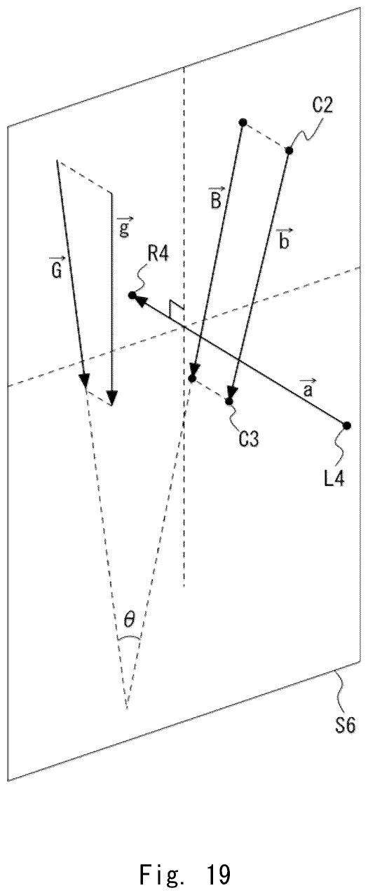

The following calculation is performed for each frame. FIG. 19 illustrates an outline of the calculation of the upper trunk forward/backward tilting in each frame. First, a plane S6, which is orthogonal to the vector a from the left waist L4 to the right waist R4, is fixed. Then, an angle θ, which is formed by a vector B obtained by projecting a vector b from the neck C2 to the waist center C3 on the plane S6 and a vector G obtained by projecting a vertical direction vector g on the plane S6, is calculated. The vertical direction vector g indicates the above-described gravity direction vector.

Then, a difference Δθ, which is obtained by subtracting the angle OF calculated in the former frame from the angle θ_{L} calculated in the later frame, is calculated as the upper trunk forward/backward tilting F6.

### [F7: The Horizontal of Pelvis]

A feature indicating the inclination of the pelvis to the right or left is defined as the horizontal of pelvis F7. Hereinafter, calculation of the horizontal of pelvis F7 will be described.

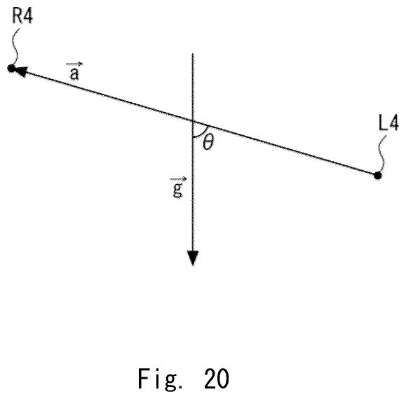

The following calculation is performed for each frame. FIG. 20 illustrates an outline of the calculation of the horizontal of pelvis in each frame. First, an angle θ, which is formed by a vector a from the left waist L4 to the right waist R4 and the vertical direction vector g, is calculated.

Then, a difference Δθ, which is obtained by subtracting the angle OF calculated in the former frame from the angle θ_{L} calculated in the later frame, is calculated as the horizontal of pelvis F7.

### [F8: Upper Trunk Lateral Bending]

The feature indicating the inclination of the upper trunk to the right or left is defined as upper trunk lateral bending F8. Hereinafter, calculation of the upper trunk lateral bending F8 will be described.

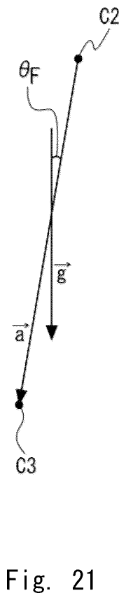

FIG. 21 illustrates an outline of the calculation of the upper trunk lateral bending in the former frame. For the former frame, an angle θ_{F}, which is formed by a vector a from the neck C2 to the waist center C3 and a vertical direction vector g, is calculated.

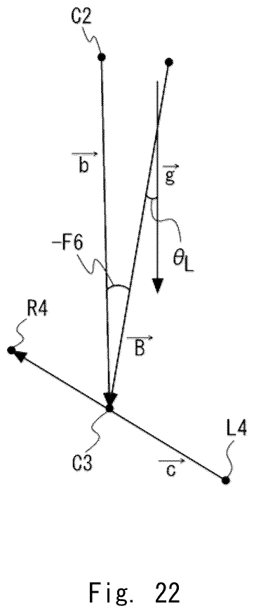

FIG. 22 illustrates an outline of the calculation of the upper trunk lateral bending in the later frame. For the later frame, a vector B is generated by rotating a vector b from the neck C2 to the waist center C3 around a vector c from the left waist L4 to the right waist R4 by a minus multiple of the upper trunk forward/backward tilting F6. Then, an angle θ_{L}, which is formed by the vector B and the vertical direction vector g, is calculated.

Then, a difference Δθ, which is obtained by subtracting the angle θ_{F} calculated in the former frame from the angle θ_{L} calculated in the later frame, is calculated as the upper trunk lateral bending F8.

### [F9: Pelvis Rotation Amount]

The feature indicating the rotation amount of the pelvis is defined as a pelvis rotation amount F9. Hereinafter, calculation of the pelvis rotation amount F9 will be described.

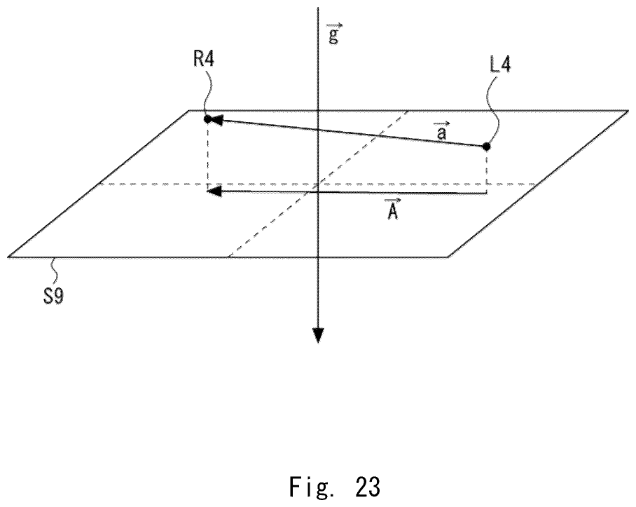

The following calculation is performed for each frame. FIG. 23 illustrates an outline of the calculation of the pelvis rotation amount in each frame. First, a plane S9, which is orthogonal to the vertical direction vector g, is fixed. Next, a vector A, which is obtained by projecting a vector a from the left waist L4 to the right waist R4 onto the plane S9, is calculated.

Then, an angle θ, which is formed by a vector A_{L} calculated in the later frame and a vector A_{F} calculated in the former frame, is calculated as the pelvis rotation amount F9.

Heretofore, step S105 has been described. Subsequently to step S105, the learning unit 109 constructs a set of data for the learning, based on the rotation feature that has been calculated, while receiving a user operation from the operation unit 107 by the user, or the like (step S106).

In step S106, for example, in accordance with the user operation, by associating the corresponding posture labels to recognize with the rotation features F0 to F9, which have been calculated by the feature calculation unit 103, the learning unit 109 constructs the data set for the learning. In this specification, “posture label to recognize” can mean “posture label to evaluate” or “posture label to assess”. Note that here, the rotation features F0 to F9 are also referred to as a rotation feature group F. For example, in a case where the object OBJ of the moving image data MOV tilts the body to the left, the state of the object OBJ is quantitatively expressed by the rotation features F0 to F9.

On the other hand, by giving information indicating the pose of the object OBJ as the posture label, it is possible to generate the data element that constitutes the data set for the learning. The data set for the learning is configured to include a plurality of data elements generated in this manner.

In other words, each data element of the data set for the learning is expressed by the following vector dᵢ. Note that i in the following equation 1 denotes an index indicating the moving image data MOV, and is an integer equal to or larger than 1 and equal to or smaller than N, in a case where N denotes the number of moving image data MOV. In addition, for the sake of convenience, variables and the like surrounded by [] in the following equation are expressed as vectors of the surrounded variables and the like.

$$[ {d}_{i} ] = ( [ {F}_{i} ] , [ {L}_{i} ] ) \qquad ( Equation 1 )$$

In the equation 1, the rotation feature group vector Fᵢ is a vector having the rotation features F0 to F9, which have been calculated from the i-th moving image data MOV, as elements. The posture label vector Lᵢ is a vector having the posture label given to the rotation feature group vector Fᵢ as an element. As described above, the data set for the learning is configured as a data set including vectors d₁ to d_{N}.

For example, the posture label may be automatically generated by applying various analysis methods to the moving image data MOV, or may be input from the operation unit 107 in accordance with the moving image data MOV by the user of the rotation state recognition system 100.

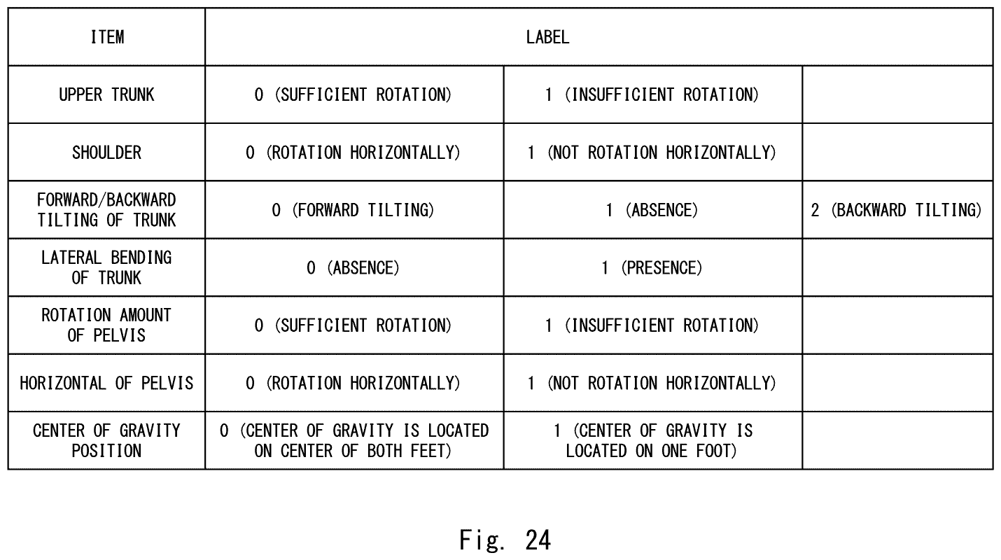

A specific example of the posture label will be described. FIG. 24 illustrates a list of posture labels to recognize. Here, as items of the posture labels to recognize, a rotation amount of upper trunk, the horizontal of shoulder, forward/backward tilting of the trunk, lateral bending of trunk, a rotation amount of pelvis, and the horizontal of pelvis are listed. In addition, regarding the center of gravity position, for example, the posture label indicating that the center of gravity is positioned at the center of both legs or the center of gravity is placed on one leg can be given. Each label can also be represented by a numerical value as illustrated in FIG. 24.

Heretofore, step S106 has been described. Subsequently to step S106, the learning unit 109 performs machine learning on the data set for the learning using supervised learning, and constructs the state estimation model 112 (step S107). The learning phase ends, accordingly. The supervised learning method is not limited to a specific method, and various supervised learning methods can be used.

### (Processing Example in Estimation Phase in Rotation State Recognition System 100)

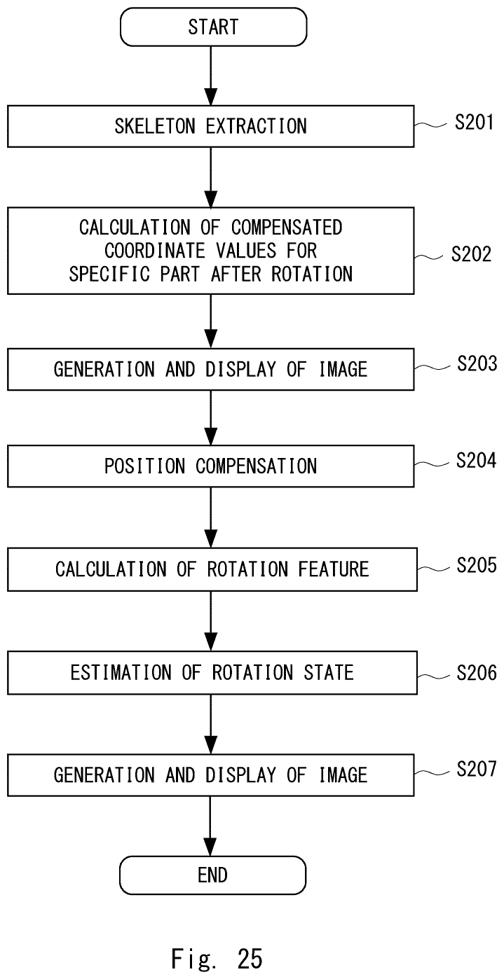

A processing example in the estimation phase in the rotation state recognition system 100 will be described with reference to FIG. 25. FIG. 25 is a flowchart for describing a processing example of the estimation phase. In this estimation phase, the learning unit 109 is not used as described above.

Also in the estimation phase, first, processing similar to that in steps S101 to S105 in FIG. 6 is performed (steps S201 to S205). However, in steps S201 to S205, processing is performed based on the moving image data MOV, which is obtained by image capturing the object OBJ, who is an estimation target, instead of the object OBJ, which is a learning target.

Regarding the generation and display of the UI images in steps S203 to S204, the generation and display of the UI images as illustrated in FIGS. 11 and 12 are basically performed similarly to the learning phase. However, regarding the information 108c1 of FIG. 11 and the information 108c2 of FIG. 12, in the estimation phase, the rotation state is estimated using the learned state estimation model 112 so that the state estimation unit 104 is used as an operation stage, which is different from the learning phase.

In step S205, the feature calculation unit 103 calculates the rotation features f0 to f9 to be input into the learned state estimation model 112. The rotation features f0 to f9 in the estimation phase respectively correspond to the rotation features F0 to F9 in the learning phase, and are calculated similarly to the learning phase. Note that here, the rotation features f0 to f9 are also referred to as a rotation feature group f. The type of the rotation feature calculated in the estimation phase may basically correspond to the type of the rotation feature calculated in the learning phase, and any rotation feature other than the rotation features f0 to f9 may be calculated.

Subsequently to step S205, the state estimation unit 104 inputs the rotation features f0 to f9 in the estimation phase into the state estimation model 112, as explanatory variables, and estimates the rotation state (step S206). In step S206, the state estimation model 112 outputs an objective variable, that is, an estimation result indicating the state of the rotation motion of the body of the object OBJ, who is an estimation target, and who appears in the moving image data MOV. As the estimation result, for example, information indicating a pose or the like including the rotation state of the object OBJ, who is an estimation target, may be output. This estimation result can be said to be a result of evaluating the rotation state of the object OBJ.

In this manner, the rotation state recognition system 100 can include an evaluation unit that evaluates the rotation state of a person, based on the rotation feature that has been calculated by the feature calculation unit 103. Although not illustrated in FIG. 4, for the sake of convenience, the evaluation unit can be included in the state estimation unit 104, included in the processing apparatus 10, or provided separately from the state estimation unit 104 and the processing apparatus 10.

Next, the state estimation unit 104 outputs the estimation result that has been obtained in this manner to the image generation unit 105. The image generation unit 105 is also capable of generating an estimation result display image to be displayed on the display unit 108, based on the estimation result that has been input from the state estimation unit 104, and generating a UI image to include the estimation result display image. In such an estimation result display image, it is possible to include an image obtained by normalizing the two images or the image after rotation captured by the camera 101, or the two silhouette images or the silhouette image after rotation. Then, the image generation unit 105 provides the display unit 108 with the UI image that has been generated. The display unit 108 displays the UI image including the estimation result display image that has been input from the image generation unit 105 (step S207). The estimation phase ends, accordingly.

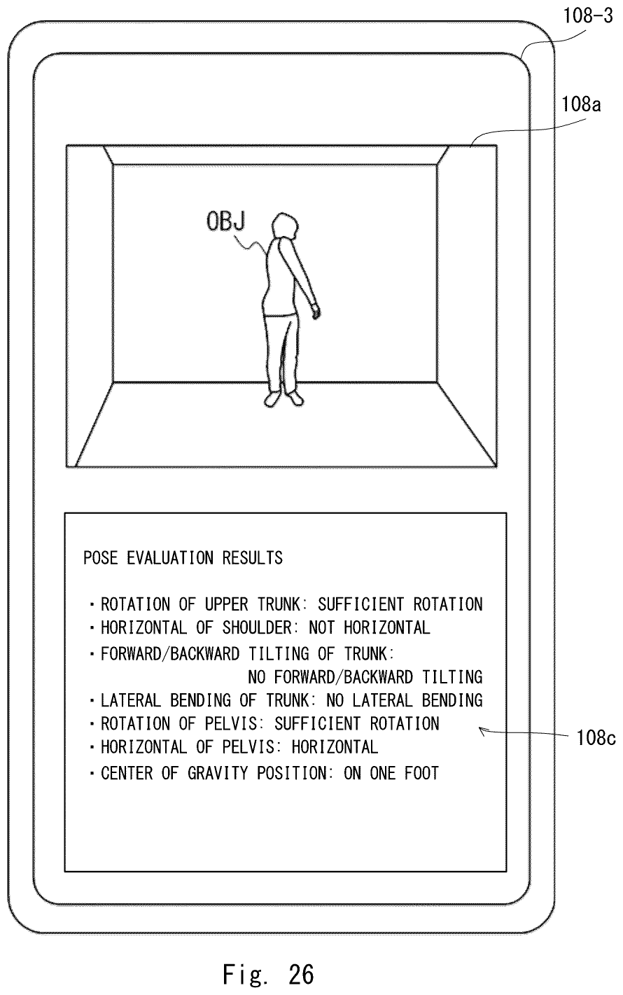

As the UI image to be generated and displayed in step S207, for example, a UI image such as a UI image 108-3 illustrated in FIG. 26 is adoptable. The UI image 108-3 displays only the image 108a, which is superimposed on the image 108a2 in the UI image 108-2 in FIG. 12 except for the marks and lines, and displays the information 108c in which the information 108c2 is not displayed in a highlighted manner. It is needless to say that, for example, one or both of a desirable result and an undesirable result in the pose evaluation result may be displayed in a highlighted manner, or a mark may be added to highlight a part relating to one or both of the above results in the image 108c. However, the example of the UI image is not limited to this, and may be, for example, the UI image 108-2 illustrated in FIG. 12. That is, in a case where the compensation is made, the extraction result of the skeleton key point may be displayed in the UI image together with the evaluation result, as a result that such compensation has been reflected.

### (Effect of Rotation State Recognition System 100)

According to the present example embodiment, it becomes possible to automatically analyze the rotation amount of a part to be analyzed of the object, such as a joint, that appears in image data or moving image data. In addition, according to the present example embodiment, it becomes also possible to estimate whether the analysis result is correct or incorrect using the state estimation model 112.

Further, it becomes possible to mount the rotation state recognition system 100 on a terminal including an image capturing apparatus such as a camera and a processing apparatus, for example, a smartphone. This enables even a general user other than an expert to analyze the rotation motion of the body and understand whether the analysis result is correct or incorrect. Using these analysis results, each user is able to perform a rehabilitation activity through online training or self-training.

### (Effect of Automatic Compensation for Key Point by Processing Apparatus 10)

Prior to describing an effect of automatic compensation for key point by the processing apparatus 10, an existing engine for estimating a skeleton key point will be described as a comparative example. Examples of such an existing engine include the following engines 1 and 2. The existing engine is a learned model that can be mounted as the skeleton extraction model 111 on the rotation state recognition system 100.
(Engine 1) mediapipe/blazepose:
<https://arxiv.org/abs/2006.10204>
(Engine 2) openpose:
<https://arxiv.org/abs/1812.08008>

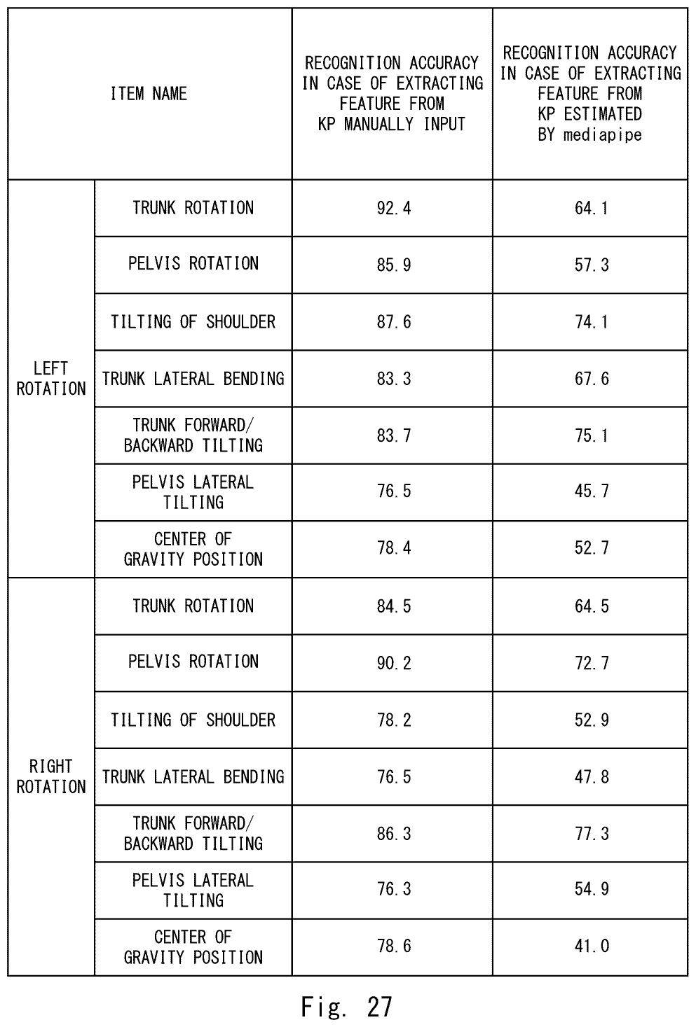

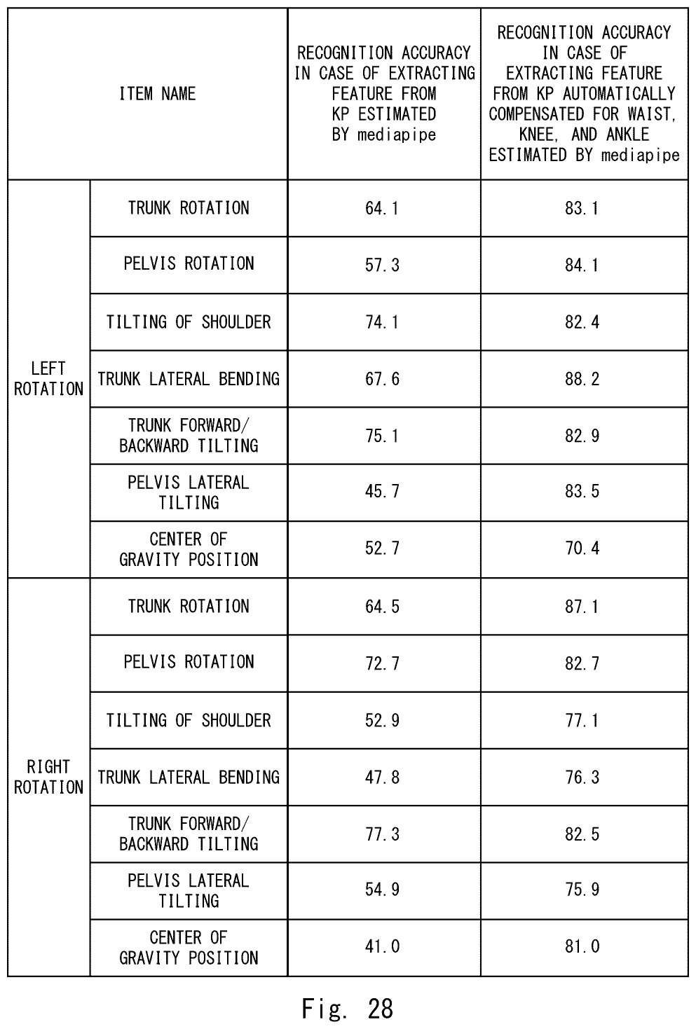

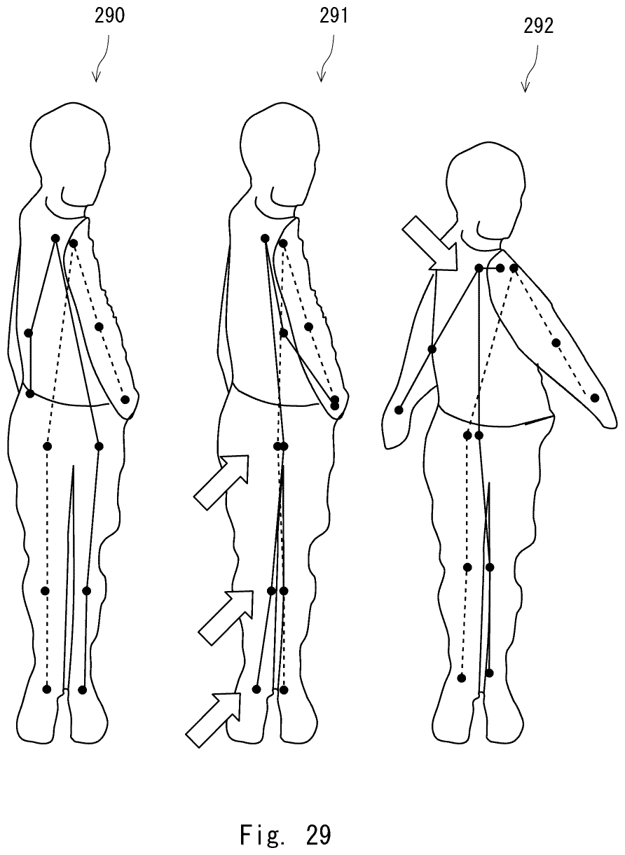

With reference to FIGS. 27 to 29, a case where the skeleton key points are only extracted using an engine 1 which is an existing engine, a case where compensation is made thereafter, and a case where a correct value is manually input are compared with one another. FIG. 27 is a view illustrating results of comparing recognition accuracy between a case where features are extracted from skeleton key points that have been manually input and a case where features are extracted from skeleton key points that have been extracted by the engine 1, which is a skeleton extraction model of a comparative example. FIG. 28 is a view illustrating results of comparing recognition accuracy between a case where features are extracted from skeleton key points that have been extracted by the engine 1 and a case where features are extracted from skeleton key points that have been extracted after a specific part is further automatically compensated. FIG. 29 is a view illustrating comparison results of the skeleton key points between the skeleton key points that have been manually input and the skeleton key points that have been extracted by the engine 1.

In FIGS. 27 and 28, regarding each of left rotation and right rotation, results obtained by testing the recognition accuracy of the items of labels of trunk rotation, pelvis rotation, tilting of shoulder, trunk lateral bending, trunk frontward/backward tilting, pelvis lateral tilting, and center of gravity position are illustrated. As illustrated in the manually input case in FIG. 27, in a case where the positions of correct skeleton key points are used, the recognition accuracy is equal to or higher than 80% in many items.

On the other hand, as illustrated in FIG. 27, in a case where the features, that is, the rotation features are extracted from the skeleton key points that have been extracted by the engine 1, the recognition accuracy is considerably lower in each item than the case of the correct values that have been manually input. In particular, as illustrated in FIG. 29, the recognition accuracy is low for poses not included in the data set for learning of the engine 1, such as the waist part, the knee part, and the ankle part indicated by arrows in a first example 291 of the skeleton key points and the shoulder part and the neck part indicated by an arrow in a second example 292 of the skeleton key points. Note that in FIG. 29, a correct answer example 290, which has been manually input, is illustrated in comparison with the first example 291 and the second example 292. In this manner, in the skeleton key points that have been extracted by the engine 1, the accuracy of recognizing the motion state during the rotation motion is lower. Note that the recognition accuracy of an engine 2 is similarly lower.

As illustrated in FIG. 28, as compared with a case where the rotation features are extracted from the skeleton key points that have been extracted by the engine 1, in a case where the processing apparatus 10 makes compensation for the skeleton key points that have been extracted by the engine 1 and then extracts the rotation features, degradation in recognition accuracy is considerably suppressed in each item. Here, the specific parts to be compensated including the waist part, the knee part, and the ankle part are illustrated as an example. In particular, as illustrated in FIG. 28, the processing apparatus 10 makes the compensation, and thus the recognition accuracy becomes equal to or higher than 80% in many items, and it is understood that such compensation is useful.

That is, if the wrong skeleton key points are used without change, the recognition accuracy of the rotation state will be low. However, in a case where the skeleton key points correctly compensated by the processing apparatus 10 are used, the recognition accuracy of the rotation state is improved. In addition, in the processing apparatus 10, such an improvement is enabled fully automatically and without cost. On the other hand, improvement of existing engines such as the engine 1 and the engine 2 necessitates data collection and model reconstruction, thereby leading to higher costs and difficulties.

Note that FIGS. 27 to 29 also illustrate types of rotation states that are not given as examples of calculation examples of the rotation features or examples of labels for state estimation. Although the details will not be described, it is sufficient that the machine learning is performed so that the state indicated by its name can be expressed also for the types of rotation states that are not given as examples.

In addition, the key point estimation engine configured with the skeleton extraction model 111 and the skeleton extraction unit 102 can be set as an engine capable of processing a silhouette image in a case where it is input, that is, an engine applicable to the silhouette image. In this case, the processing apparatus 10 only has to perform processing using information indicating silhouettes of the two images that have been input, and does not have to perform processing using the images themselves. Thus, it is also possible to perform the operation using only the silhouette images in consideration of privacy.

### Third Example Embodiment

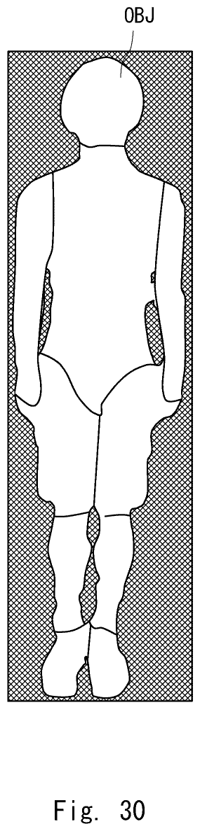

An application example for a case where the segmentation technique that has been described in the second example embodiment is used will be described as a third example embodiment with reference to FIG. 30. FIG. 30 is a schematic view illustrating the segmentation technique.

The processing apparatus 10 or the rotation state recognition apparatus 10a may include a first machine learning model, not illustrated, in its inside or in the storage unit 110. Such a first machine learning model receives inputs of the compensated coordinate values that have been calculated for the specific part after rotation, and the skeleton key point coordinate evaluation values of the specific part at the time of standing and another part at the time of standing and after rotation. The first machine learning model outputs the rotation feature or the rotation state. That is, the first machine learning model is a model obtained by the machine learning to output in an above-described manner with respect to the above-described inputs. In a case where the model outputs the rotation feature, the model can be included in the feature calculation unit 103. On the other hand, in a case where the model outputs the rotation state, the model serves as the state estimation model 112.

Then, the calculation unit 12 may include, in its inside or in the storage unit 110, a second machine learning model that receives inputs of two silhouette images and that is obtained by the machine learning so as to do segmentation for classifying parts of a person.

An algorithm or the like of each the first machine learning model and the second machine learning model is not limited, and it is sufficient it is a learned model capable of obtaining necessary output with respect to the input. As illustrated in FIG. 30, the segmentation technique is a technique for segmenting the object OBJ, which is a person, into every predetermined part. In FIG. 30, the boundary of the segmentation is merely indicated by a line, but an index can be applied or each part can be colored.

Then, the processing apparatus 10 or the rotation state recognition apparatus 10a can include an adjustment unit, not illustrated, that receives an input of the accuracy of the first machine learning model and that adjusts setting parameters in the second machine learning model, based on the accuracy, so as to improve the accuracy. The accuracy of the first machine learning model may be determined by being automatically compared with the value that has been manually input, or a model constructor may determine and input the accuracy.

The adjustment unit can be included in the learning unit 109. The above setting parameter represents, for example, a threshold of similarity between pixels, and can include one or a plurality of a scale parameter that most affects the size of an object to be generated and a parameter for controlling the roughness of detection accuracy. In addition, examples of the above setting parameter can include one or a plurality of a parameter for controlling the degree of removing an object with low reliability, a parameter for controlling the degree of avoiding duplicate detection, and a parameter for balance between color and shape.

In this manner, the adjustment unit is capable of tuning the setting parameter in the second machine learning model as a hyperparameter of the first machine learning model. The adjustment unit can also be referred to as a tuning unit. Such tuning enables the second machine learning model for doing the segmentation to be subjected to the machine learning so as to have a form suitable for use in the skeleton key point compensation. Therefore, such tuning enables improvement in the accuracy of the compensation of the skeleton key points including the accuracy of processing the segmentation used in the calculation unit 12. For example, it becomes possible to achieve automation with high accuracy while suppressing the input for the presence or absence of the compensation by the user.

### Fourth Example Embodiment

As a fourth example embodiment, another application example using the above-described first machine learning model will be described.

Also in the present example embodiment, similarly to the third example embodiment, the processing apparatus 10 or the rotation state recognition apparatus 10a includes the first machine learning model in its inside or in the storage unit 110. Then, the calculation unit 12 may include, in its inside or in the storage unit 110, a machine learning model for determination that receives an input of at least one of the two images, the two silhouette images, and the rotation feature and that is obtained by the machine learning so as to determine whether the compensated coordinate values are to be applied. For any of the first machine learning model and the machine learning model for determination, an algorithm or the like is not limited, it is sufficient if it is a learned model capable of obtaining necessary output with respect to the input.

Then, the processing apparatus 10 or the rotation state recognition apparatus 10a can include an adjustment unit, not illustrated, that receives an input of the accuracy of the first machine learning model and that adjusts the machine learning model for determination so as to improve the accuracy. The adjustment unit can be included in the learning unit 109. Also in such adjustment, the setting parameter of the machine learning model for determination can be adjusted. Examples of the setting parameter can include one or a plurality of a parameter for controlling weighting between the rotation features, and a parameter for adjusting resolution for use in reading an image.

In this manner, the adjustment unit is capable of tuning the setting parameter in the machine learning model for determination as a hyperparameter of the first machine learning model. This adjustment unit can also be referred to as a tuning unit. Such tuning enables the machine learning model for determination for determining applying of the compensation to be subjected to the machine learning so as to have a form suitable for use in the skeleton key point compensation. Therefore, such tuning enables improvement in the accuracy of the compensation of the skeleton key points including the accuracy of the machine learning model for determination. For example, it becomes possible to achieve automation with high accuracy while suppressing the input for the presence or absence of the compensation by the user.

### Fifth Example Embodiment

In the second to fourth example embodiments, the descriptions have been made for the analysis of the rotation motion in one direction of the body of the object OBJ from the rotation feature in consideration of only the rotation motion in one direction of the body of the object OBJ without considering the left-right symmetry. However, the human body can make symmetric motions respectively to the left and right. However, even though the object intends to make a symmetric motion, there is a case where the object is not able to actually make a symmetric motion due to a problem of a joint or the like. Hence, in the present example embodiment, a method for evaluating the left-right symmetry of the motion of the object OBJ will be described. That is, in the present example embodiment, the processing is performed for both a case of left rotation and a case of right rotation so as to consider the left-right symmetry.

Although its detailed processing example is omitted, moving image data MOV_L in a case where the body is turned and twisted to the left and moving image data MOV_R in a case where the body is turned and twisted to the right are imaged by the camera 101. Hereinafter, two moving image data in which the left-right symmetric motion of an identical object is recorded will be referred to as a moving image pair MP. Then, in the present example embodiment, it is sufficient to perform the processing as described in the second to fourth example embodiments for both pieces of the captured moving image data.

Briefly describing a processing example, the skeleton extraction unit 102 receives a gravity direction vector, input information, and the moving image pair MP. The skeleton extraction unit 102 and the processing apparatus 10 obtain a skeleton key point coordinate estimation value group from each the moving image data MOV_L and the moving image data MOV_R included in the moving image pair MP, and a compensated coordinate value for a specific part after rotation of them. Here, PL denotes a skeleton key point coordinate value group corresponding to the moving image data MOV_L, and PR denotes a skeleton key point coordinate value group corresponding to the moving image data MOV_R.

The feature calculation unit 103 extracts a rotation feature based on the skeleton key point coordinate value group that has been input from the output unit 13 for each the moving image data MOV_L and the moving image data MOV_R, which are included in the moving image pair MP. Here, the rotation features F0 to F9, which have been extracted from the moving image data MOV_L, will be expressed as a rotation feature group FL, and the rotation features F0 to F9, which have been extracted from the moving image data MOV_R, will be expressed as a rotation feature group FR.

That is, the feature calculation unit 103 calculates the rotation features F0 to F9, that is, the rotation feature group FL based on the skeleton key point coordinate value group PL, and calculates the rotation features F0 to F9, that is, the rotation feature group FR based on the skeleton key point coordinate value group PR.

The learning unit 109 constructs a data set for the learning including a plurality of data elements including the rotation feature group FL and the rotation feature group FR related to one moving image pair MP and the posture label L indicating the left-right symmetry of the motion.

In other words, each data element of the data for the learning is expressed by the following vector eⱼ. Note that j in the following equation 2 denotes an index indicating a moving image pair, and is an integer equal to or larger than 1 and equal to or smaller than M, in a case where M denotes the number of moving image pairs.

$$[ {e}_{j} ] = ( [ {FL}_{j} ] , [ {FR}_{j} ] , [ {L}_{j} ] ) \qquad ( Equation 2 )$$

In the equation 2, the rotation feature group vector FLⱼ is a vector having the rotation features F0 to F9, as elements, that have been calculated for the moving image data MOV_L of the j-th moving image pair. The rotation feature group vector FRⱼ is a vector having the rotation features F0 to F9, as elements, that have been calculated for the moving image data MOV_R of the j-th moving image pair. A posture label vector Lⱼ is a vector having posture labels to recognize, as elements, that have been given to the rotation feature group vectors FLⱼ and FRⱼ. As described heretofore, the data set for the learning is configured as a data set including vectors e₁to e_{M}.

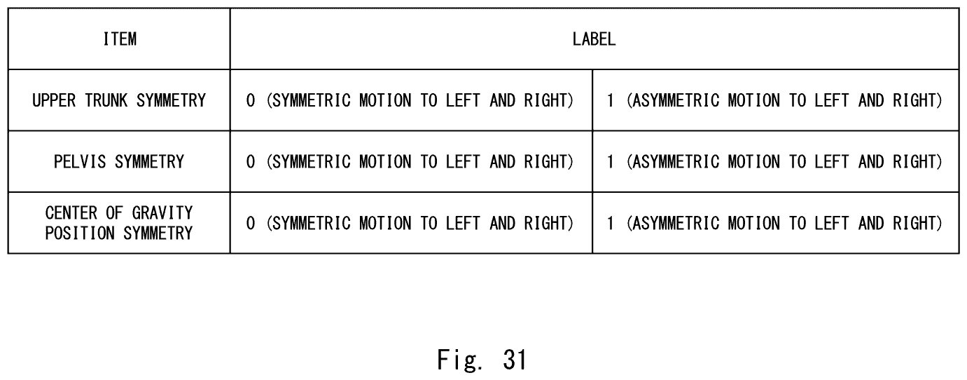

In the present example embodiment, the label for the learning may include a label indicating the symmetry of the upper trunk, the symmetry of the pelvis, and the symmetry of the center of gravity position, as a label indicating the left-right symmetry of the motion of a human body. FIG. 31 illustrates a list of posture labels to recognize. Here, it is assumed that a label indicating whether each item is “symmetric motion to the left and right” or “asymmetric motion to the left and right” is given. For example, “0” may be given in the case of “symmetric motion to the left and right”, and “1” may be given in the case of “asymmetric motion to the left and right”.

For example, in a case where the object makes a left rotation motion of twisting the body to the left, a case where the center of gravity is shifted to the left foot due to a physical trouble is assumed. In this case, in a case where the center of gravity is shifted to the right foot at the time of rotation motion to the right, “0” is given as the posture label of the center of gravity position symmetry, and in the other cases, “1” is given. In addition, in a case where the center of gravity is located at the center of both feet at the time of rotation motion to the left, in a case where the center of gravity is located at the center of both feet at the time of rotation motion to the right, “0” is given as the posture label of the center of gravity position symmetry, and in the other cases, “1” is given.

Next, the learning unit 109 learns the data set for the learning using supervised learning, and constructs the state estimation model 112.

Heretofore, the learning phase has been described, and the estimation phase will be described next. Also in the estimation phase, the processing of the skeleton extraction unit 102, the processing apparatus 10, and the feature calculation unit 103 is similar to that in the learning phase. The feature calculation unit 103 receives an input of necessary information such as the moving image pair MP and the skeleton key point coordinate value groups PL and PR of the object, who is an estimation target, and calculates the rotation feature groups fL and fR. The rotation feature groups fL and fR in the estimation phase respectively correspond to the rotation feature groups FL and FR in the learning phase, and are calculated similarly to those in the learning phase.

Next, the state estimation unit 104 inputs the rotation feature groups fL and fR in the estimation phase to the state estimation model that is held, as explanatory variables, and thus outputs, as an estimation result, an objective variable indicating the left-right symmetry of the motion of the object, who is an estimation target, and who appears in the moving image pair MP. This enables determination of whether the symmetry of the upper trunk, the symmetry of the pelvis, and the symmetry of the center of gravity position are balanced on the left and right in accordance with the estimation result.

In the present example embodiment, in the learning phase, the machine learning is performed using the data set for the learning for rotation motions to the left and right, and a learned state estimation model for evaluating left and right symmetry is constructed, so that the left and right symmetry can be evaluated in the estimation phase. Also in such an evaluation, the skeleton key points are correctly compensated, which is useful.

Therefore, according to the present example embodiment, it becomes possible not only to analyze the pose of the object who appears in the moving image and the rotation motion of the body in one direction but also to further analyze the left-right symmetry of the rotation motion of the body of the object. This enables a more comprehensive analysis of the rotation motion of the body.

### Sixth Example Embodiment

In each of the above-described example embodiments, it is necessary to acquire the gravity direction vector in order to compensate the position of the skeleton key point. In addition, in the second example embodiment, it is necessary to obtain the vertical direction vector g in the calculation of the upper trunk forward/backward tilting F6, the horizontal of pelvis F7, the upper trunk lateral bending F8, and the pelvis rotation amount F9. Regarding the vertical direction vector g, it is possible to determine its direction beforehand, for example, by checking the horizontal in a case where the camera 101 is installed. However, in this method, manual work is needed. Hence, in a case where it is possible to automatically acquire the vertical direction vector g, which is useful. Therefore, in the present example embodiment, a rotation state recognition system capable of automatically acquiring the vertical direction vector g, which is a gravity direction vector, will be described.

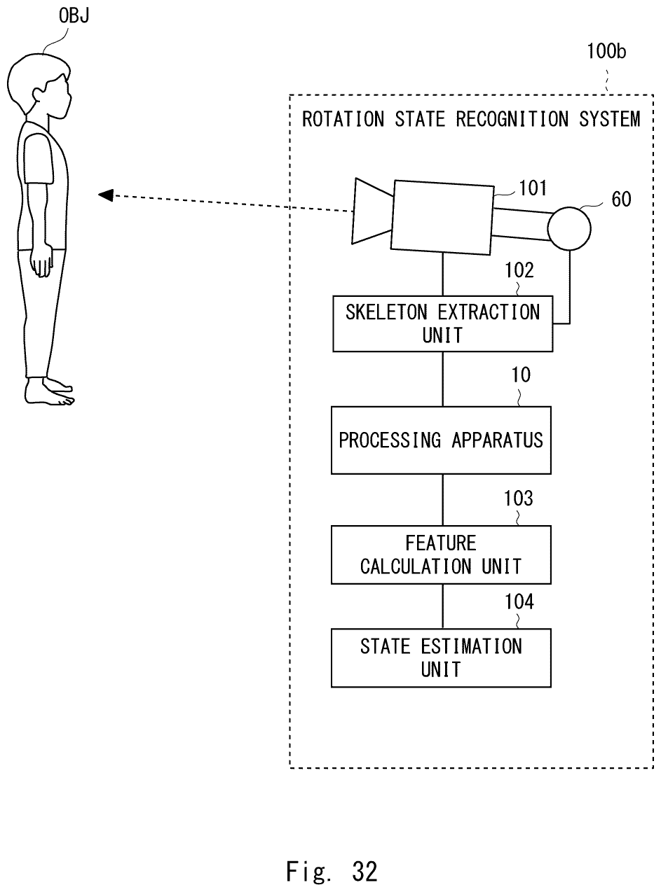

The rotation state recognition system 100b will be described with reference to FIG. 32. The rotation state recognition system 100b has a configuration in which an acceleration sensor 60 is added to the rotation state recognition system 100 according to the second to fifth example embodiments. In this example, the acceleration sensor 60 is physically fixed to the camera 101. In a case where capturing the moving image data MOV, the acceleration sensor 60 outputs, to the rotation state recognition apparatus 10a, gravity direction information GV indicating which direction the gravity direction is with respect to the pose of the camera 101. The gravity direction information GV is an example of the gravity direction vector or information indicating the gravity direction vector.

This enables the rotation state recognition apparatus 10a to set the optimal vertical direction vector g for every piece of the moving image data MOV, by using the gravity direction indicated by the gravity direction information GV as the direction of the vertical direction vector g.

Note that here, the description has been made that the acceleration sensor 60 is fixed to the camera 101. However, it is possible to provide the acceleration sensor 60 at any position and in any method, as long as the gravity direction is detectable in association with an image or moving image data.

Heretofore, according to the present example embodiment, it becomes possible to automatically acquire the vertical direction vector g. For example, in a case where the rotation state recognition system is mounted on a terminal, such as a smartphone, capable of performing software processing and equipped with an acceleration sensor and a camera, the vertical direction vector g is easily acquirable.

### Other Example Embodiments

Note that the present invention is not limited to the above example embodiments, and can be appropriately changed without departing from the gist.

For example, in the above-described example embodiment, the description has been made that the skeleton extraction unit 102 uses the skeleton key point as the feature point extracted from the object. However, this is merely an example for parts other than the specific part, and any other feature point may be used. In addition, a plurality of types of feature points extracted in different extraction methods may be used together for each part including the specific part. For example, a silhouette of the object in each frame of the moving image may be detected, and a point on the contour of the silhouette may be extracted as a feature point. Further, the skeleton key point and the point on the contour of the silhouette may be used together as the feature points.

In addition, in each example embodiment, as the description has been made as a processing example of the processing apparatus 1 or the processing apparatus 10, the present disclosure also includes an aspect as a processing method executed by a computer. Further, in each example embodiment, as the description has been made as a processing example of the rotation state recognition system 100 and the like, the present disclosure also includes an aspect as a rotation state recognition method performed by a computer.

In addition, the processing performed by the processing apparatus or the rotation state recognition system according to each example embodiment may be achieved by causing a computer to execute a program as described above. Specifically, it is sufficient if one or a plurality of programs including an instruction group for causing a computer system to perform an algorithm related to the calculation processing of the compensated coordinate values and the rotation state recognition processing may be created, and the program is supplied to the computer.

Further, the above-described program includes an instruction group (or software codes) for causing a computer to perform one or more functions that have been described in the example embodiments, in a case where the program is read by the computer. The program may be stored in a non-transitory computer readable medium or a tangible storage medium. Examples of the computer readable medium or tangible storage medium includes, but are not limited to, a random-access memory (RAM), a read-only memory (ROM), a flash memory, a solid-state drive (SSD), and any other memory technology. In addition, examples of the computer readable medium or tangible storage medium include, but are not limited to, CD-ROMs, digital versatile discs (DVD), Blu-ray (registered trademark) discs or any other optical disk storages, magnetic cassettes, magnetic tape, magnetic disk storage or any other magnetic storage devices. The program may be transmitted on a transitory computer readable medium or a communications medium. Examples of a transitory computer readable medium or communication medium include, but are not limited to, electrical, optical, acoustic, or any other form of propagation signals.

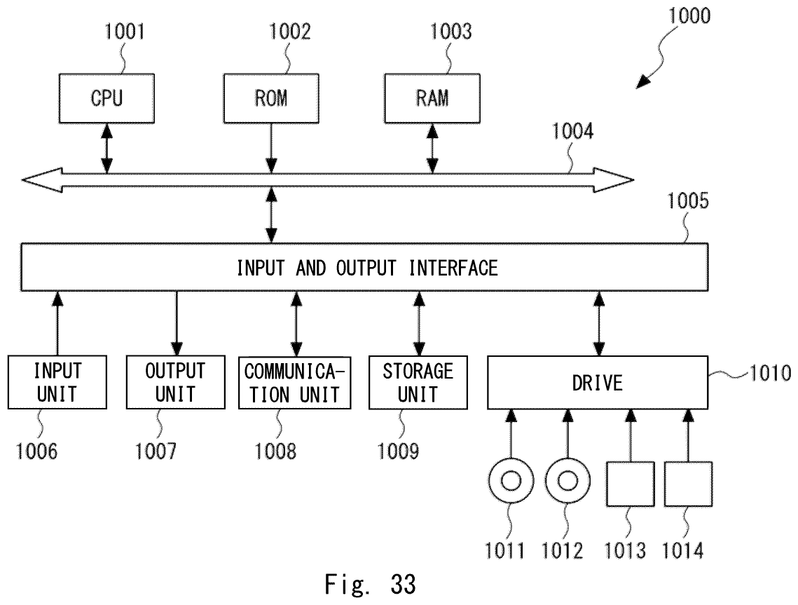

FIG. 33 schematically illustrates a configuration of a computer 1000, which is an example of a hardware configuration for achieving the processing apparatus or the rotation state recognition system. The computer 1000 is configured as various computers such as a dedicated computer and a personal computer (PC). However, the computer does not have to be physically single, and a plurality of computers may be provided, in a case where distributed processing is performed. As illustrated in FIG. 33, the computer 1000 includes a central processing unit (CPU) 1001, a read only memory (ROM) 1002, and a random access memory (RAM) 1003. In the computer 1000, the CPU 1001, the ROM 1002, and the RAM 1003 are connected with one another through a bus 1004. Note that although the description of OS software and the like for operating the computer is omitted, it is obviously assumed to be included also in this computer.

An input and output interface 1005 is also connected with the bus 1004. An input unit 1006, an output unit 1007, a communication unit 1008, and a storage unit 1009 are connected with the input and output interface 1005.

The input unit 1006 includes, for example, a keyboard, a mouse, a sensor, and the like. The output unit 1007 includes, for example, a display device such as an LCD or an audio output device such as a headphone or a speaker. The communication unit 1008 includes, for example, a router, a terminal adapter, and the like. The storage unit 1009 includes a storage device such as a hard disk or a flash memory.

The CPU 1001 is capable of performing various types of processing in accordance with various programs stored in the ROM 1002 or various programs loaded from the storage unit 1009 into the RAM 1003. In this example, the CPU 1001 performs processing to be performed by the processing apparatus or the rotation state recognition system, for example. A GPU may be provided separately from the CPU 1001, and similarly to the CPU 1001, may perform various types of processing in accordance with various programs stored in the ROM 1002 or various programs loaded from the storage unit 1009 to the RAM 1003. In this example, the GPU may perform processing to be performed by the processing apparatus or the rotation state recognition system, for example. GPU is an abbreviation for graphics processing unit. Note that the GPU is suitable for an application of performing typical processing in parallel, and is applied to processing in a neural network or the like, so that the processing speed can be increased as compared with the CPU 1001. In the RAM 1003, data and the like necessary for the CPU 1001 and the GPU to perform various types of processing is appropriately stored.

The communication unit 1008 is capable of communicating bidirectionally with the server 1030 through the network 1020. The communication unit 1008 is capable of transmitting data provided from the CPU 1001 to the server 1030, and is capable of outputting data that has been received from the server 1030 to the CPU 1001, the RAM 1003, the storage unit 1009, and the like. The communication unit 1008 may communicate with another device using an analog signal or a digital signal. The storage unit 1009 is capable of exchanging data with the CPU 1001, and saves and erases information.

A drive 1010 may be connected to the input and output interface 1005 as necessary. For example, it is possible to appropriately attach, to the drive 1010, a storage medium such as a magnetic disk 1011, an optical disk 1012, a flexible disk 1013, or a semiconductor memory 1014. The computer program that has been read from each storage medium may be installed in the storage unit 1009 as necessary. In addition, data necessary for the CPU 1001 to perform various types of processing, data obtained as a result of the processing by the CPU 1001, and the like may be stored in each storage medium as necessary.

In each of the above-described example embodiments, that description has been made that image data and moving image data are acquired by a camera, but this is merely an example. The image data and the moving image data is acquirable with various types of any image capturing apparatus.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as in the following Supplementary Notes, but are not limited to the following Supplementary Notes.

### (Supplementary Note 1)

A processing apparatus including:
an input unit configured to receive inputs of either three-dimensional or two-dimensional skeleton key point coordinate estimation values and a gravity direction vector as input information for two images obtained by image capturing a frontal plane of a person at a time of standing and after rotation;
a calculation unit configured to calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and
an output unit configured to output the compensated coordinate values that have been calculated.

### (Supplementary Note 2)

The processing apparatus described in Supplementary Note 1, further including a position compensation unit configured to compensate the skeleton key point coordinate estimation values of the specific part in the image after the rotation to the compensated coordinate values.

### (Supplementary Note 3)

The processing apparatus described in Supplementary Note 2, in which the output unit outputs the compensated coordinate values for the specific part in the image after the rotation, together with the skeleton key point coordinate estimation values of another part.

### (Supplementary Note 4)

The processing apparatus described in Supplementary Note 2 or 3, in which
the output unit outputs the skeleton key point coordinate estimation values of the specific part after the rotation to be included in a user interface image displayed on a display apparatus, together with the compensated coordinate values for the specific part, and
the user interface image includes an image that receives a user operation for designating whether to execute the compensation.

### (Supplementary Note 5)

The processing apparatus described in one of Supplementary Notes 1 to 4, in which the output unit outputs the compensated coordinate values for the specific part to be included in a user interface image displayed on a display apparatus.

### (Supplementary Note 6)

The processing apparatus described in one of Supplementary Notes 1 to 5, further including a feature calculation unit configured to calculate a feature indicating a rotation state of the person, based on the compensated coordinate values for the specific part, and the skeleton key point coordinate estimation values of the specific part at the time of standing and another part at the time of standing and after the rotation.

### (Supplementary Note 7)

The processing apparatus described in Supplementary Note 6, further including an evaluation unit configured to evaluate a rotation state of the person, based on the feature.

### (Supplementary Note 8)

The processing apparatus described in one of Supplementary Notes 1 to 7, in which
the input information includes the two images, and
the calculation unit generates the two silhouette images from the two images.

### (Supplementary Note 9)

The processing apparatus described in one of Supplementary Notes 1 to 7, in which the input information includes the two silhouette images as the two images.

### (Supplementary Note 10)

The processing apparatus described in Supplementary Note 6 or 7, further including a first machine learning model obtained by machine learning to receive inputs of the compensated coordinate values for the specific part and the skeleton key point coordinate estimation values of the specific part at the time of standing and another part at the time of standing and after the rotation, and to output either the feature or the rotation state of the person, in which
the calculation unit includes a second machine learning model obtained by the machine learning to receive inputs of the two silhouette images, and to do segmentation for classifying parts of the person, and
the processing apparatus includes an adjustment unit configured to receive an input of accuracy of the first machine learning model, and to adjust a setting parameter in the second machine learning model, based on the accuracy, to improve the accuracy.

### (Supplementary Note 11)

The processing apparatus described in Supplementary Note 6 or 7, further including a first machine learning model obtained by machine learning to receive inputs of the compensated coordinate values for the specific part and the skeleton key point coordinate estimation values of the specific part at the time of standing and another part at the time of standing and after the rotation, and to output either the feature or the rotation state of the person, in which
the calculation unit includes a machine learning model for determination obtained by the machine learning to receive at least one of inputs of the two images, the two silhouette images, and the feature, and to determine whether the compensated coordinate values are to be applied, and
the processing apparatus includes an adjustment unit configured to execute the instructions to receive an input of accuracy of the first machine learning model, and to adjust a setting parameter in the machine learning model for determination, based on the accuracy, to improve the accuracy.

### (Supplementary Note 12)

The processing apparatus described in one of Supplementary Notes 1 to 11, in which
the specific part includes left and right waists, and
the calculation unit calculates a width between the left and right waists as a width of the specific part from each of the two silhouette images, and to calculate compensated coordinate values for skeleton key point coordinate estimation values of the left and right waists in the image after the rotation, as a position having a waist rotation angle inversely calculated from a ratio of the width between the left and right waists in the two silhouette images that have been calculated in a plane orthogonal to the gravity direction vector.

### (Supplementary Note 13)

The processing apparatus described in one of Supplementary Notes 1 to 12, in which
the specific part includes left and right shoulders, and
the calculation unit calculates a width between the left and right shoulders as a width of the specific part from each of the two silhouette images, and to calculate compensated coordinate values for skeleton key point coordinate estimation values of the left and right shoulders in the image after the rotation, as a position having a shoulder rotation angle inversely calculated from a ratio of the width between the left and right shoulders that have been calculated in a plane orthogonal to the gravity direction vector.

### (Supplementary Note 14)

The processing apparatus described in one of Supplementary Notes 1 to 13, in which
the specific part includes left and right knees, and
the calculation unit calculates widths of the left and right knees from a silhouette image at the time of standing out of the two silhouette images, and to calculate compensated coordinate values for skeleton key point coordinate estimation values of the left and right knees in the image after the rotation, as positions respectively shifted inward in a silhouette image after the rotation from edges of the silhouette image after the rotation by lengths respectively proportional to the widths of the left and right knees that have been calculated, in a plane orthogonal to the gravity direction vector.

### (Supplementary Note 15)

The processing apparatus described in one of Supplementary Notes 1 to 14, in which
the specific part includes left and right ankles, and
the calculation unit calculates widths of the left and right ankles from a silhouette image at the time of standing out of the two silhouette images, and to calculate compensated coordinate values for skeleton key point coordinate estimation values of the left and right ankles in the image after the rotation, as positions respectively shifted inward in a silhouette image after the rotation from edges of the silhouette image after the rotation by lengths respectively proportional to the widths of the left and right ankles that have been calculated, in a plane orthogonal to the gravity direction vector.

### (Supplementary Note 16)

A processing method for causing a computer to:
receive inputs of either three-dimensional or two-dimensional skeleton key point coordinate estimation values and a gravity direction vector as input information for two images obtained by image capturing a frontal plane of a person at a time of standing and after rotation;
calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and
output the compensated coordinate values that have been calculated.

### (Supplementary Note 17)

A program for causing a computer to:
receive inputs of either three-dimensional or two-dimensional skeleton key point coordinate estimation values and a gravity direction vector as input information for two images obtained by image capturing a frontal plane of a person at a time of standing and after rotation;
calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and
output the compensated coordinate values that have been calculated.

Some or all of the elements (for example, configurations and functions) that have been described in Supplementary Notes 2 to 15, which are dependent from Supplementary Note 1, may depend from Supplementary Notes 16 and 17 as well with dependency relationships similar to those of Supplementary Notes 2 to 15. Some or all of the elements that have been described in any supplementary note are applicable to various types of hardware, software, recording means for recording software, systems, and methods.

What is claimed is:

1. A processing apparatus comprising:
at least one memory configured to store instructions, and
at least one processor configured to execute the instructions to:
receive inputs of either three-dimensional or two-dimensional skeleton key point coordinate estimation values and a gravity direction vector as input information for two images obtained by image capturing a frontal plane of a person at a time of standing and after rotation;
calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and
output the compensated coordinate values that have been calculated.

2. The processing apparatus according to claim 1, wherein the at least one processor is further configured to execute the instructions to compensate the skeleton key point coordinate estimation values of the specific part in the image after the rotation to the compensated coordinate values.

3. The processing apparatus according to claim 2, wherein the at least one processor is configured to execute the instructions to output the compensated coordinate values for the specific part in the image after the rotation, together with the skeleton key point coordinate estimation values of another part.

4. The processing apparatus according to claim 2, wherein
the at least one processor is configured to execute the instructions to output the skeleton key point coordinate estimation values of the specific part after the rotation to be included in a user interface image displayed on a display apparatus, together with the compensated coordinate values for the specific part, and
the user interface image includes an image that receives a user operation for designating whether to execute the compensation.

5. The processing apparatus according to claim 1, wherein the at least one processor is configured to execute the instructions to output the compensated coordinate values for the specific part to be included in a user interface image displayed on a display apparatus.

6. The processing apparatus according to claim 1, wherein the at least one processor is further configured to execute the instructions to calculate a feature indicating a rotation state of the person, based on the compensated coordinate values for the specific part, and the skeleton key point coordinate estimation values of the specific part at the time of standing and another part at the time of standing and after the rotation.

7. The processing apparatus according to claim 6, wherein the at least one processor is further configured to execute the instructions to evaluate a rotation state of the person, based on the feature.

8. The processing apparatus according to claim 1, wherein
the input information includes the two images, and
the at least one processor is configured to execute the instructions to generate the two silhouette images from the two images.

9. The processing apparatus according to claim 1, wherein the input information includes the two silhouette images as the two images.

10. The processing apparatus according to claim 6, wherein
the at least one memory is configured to store:
a first machine learning model obtained by machine learning to receive inputs of the compensated coordinate values for the specific part and the skeleton key point coordinate estimation values of the specific part at the time of standing and another part at the time of standing and after the rotation, and to output either the feature or the rotation state of the person; and
a second machine learning model obtained by the machine learning to receive inputs of the two silhouette images, and to do segmentation for classifying parts of the person, and
the at least one processor is further configured to execute the instructions to receive an input of accuracy of the first machine learning model, and to adjust a setting parameter in the second machine learning model, based on the accuracy, to improve the accuracy.

11. The processing apparatus according to claim 6, wherein
the at least one memory is configured to store:
a first machine learning model obtained by machine learning to receive inputs of the compensated coordinate values for the specific part and the skeleton key point coordinate estimation values of the specific part at the time of standing and another part at the time of standing and after the rotation, and to output either the feature or the rotation state of the person; and
a machine learning model for determination obtained by the machine learning to receive at least one of inputs of the two images, the two silhouette images, and the feature, and to determine whether the compensated coordinate values are to be applied, and
the at least one processor is further configured to execute the instructions to receive an input of accuracy of the first machine learning model, and to adjust a setting parameter in the machine learning model for determination, based on the accuracy, to improve the accuracy.

12. The processing apparatus according to claim 1, wherein
the specific part includes left and right waists, and
the at least one processor is configured to execute the instructions to calculate a width between the left and right waists as a width of the specific part from each of the two silhouette images, and to calculate compensated coordinate values for skeleton key point coordinate estimation values of the left and right waists in the image after the rotation, as a position having a waist rotation angle inversely calculated from a ratio of the width between the left and right waists in the two silhouette images that have been calculated in a plane orthogonal to the gravity direction vector.

13. The processing apparatus according to claim 1, wherein
the specific part includes left and right shoulders, and
the at least one processor is configured to execute the instructions to calculate a width between the left and right shoulders as a width of the specific part from each of the two silhouette images, and to calculate compensated coordinate values for skeleton key point coordinate estimation values of the left and right shoulders in the image after the rotation, as a position having a shoulder rotation angle inversely calculated from a ratio of the width between the left and right shoulders that have been calculated in a plane orthogonal to the gravity direction vector.

14. The processing apparatus according to claim 1, wherein
the specific part includes left and right knees, and
the at least one processor is configured to execute the instructions to calculate widths of the left and right knees from a silhouette image at the time of standing out of the two silhouette images, and to calculate compensated coordinate values for skeleton key point coordinate estimation values of the left and right knees in the image after the rotation, as positions respectively shifted inward in a silhouette image after the rotation from edges of the silhouette image after the rotation by lengths respectively proportional to the widths of the left and right knees that have been calculated, in a plane orthogonal to the gravity direction vector.

15. The processing apparatus according to claim 1, wherein
the specific part includes left and right ankles, and
the at least one processor is configured to execute the instructions to calculate widths of the left and right ankles from a silhouette image at the time of standing out of the two silhouette images, and to calculate compensated coordinate values for skeleton key point coordinate estimation values of the left and right ankles in the image after the rotation, as positions respectively shifted inward in a silhouette image after the rotation from edges of the silhouette image after the rotation by lengths respectively proportional to the widths of the left and right ankles that have been calculated, in a plane orthogonal to the gravity direction vector.

16. A processing method for causing a computer to:
receive inputs of either three-dimensional or two-dimensional skeleton key point coordinate estimation values and a gravity direction vector as input information for two images obtained by image capturing a frontal plane of a person at a time of standing and after rotation;
calculate a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and
output the compensated coordinate values that have been calculated.

17. A non-transitory computer readable medium storing a program for causing a computer to execute the following processing of:
receiving inputs of either three-dimensional or two-dimensional skeleton key point coordinate estimation values and a gravity direction vector as input information for two images obtained by image capturing a frontal plane of a person at a time of standing and after rotation;
calculating a width of a specific part from each of two silhouette images respectively indicating silhouettes of the two images, collate the width of the specific part that has been calculated and the gravity direction vector with anatomical knowledge, and calculate compensated coordinate values for the skeleton key point coordinate estimation values of the specific part in an image after the rotation; and
outputting the compensated coordinate values that have been calculated.
